(19) United States
(12) Patent Application Publication
(10) Pub. No.: US 2025/0321535 A1
(43) Pub. Date: Oct. 16, 2025

(54) DEVELOPER SUPPLY CONTAINER, DEVELOPER SUPPLY CONTAINER SET, CONTAINER UNIT, AND IMAGE FORMING SYSTEM

(71) Applicant: CANON KABUSHIKI KAISHA, Tokyo (JP)

(72) Inventors: SEIYA ISHIKAWA, Tokyo (JP); HIROYUKI MUNETSUGU, Kanagawa (JP); GOSHI OZAKI, Kanagawa (JP); MITSUHIRO SATO, Tokyo (JP)

(21) Appl. No.: 19/249,242

(22) Filed: Jun. 25, 2025

Related U.S. Application Data
(63) Continuation of application No. PCT/JP2023/046733, filed on Dec. 26, 2023.

(30) Foreign Application Priority Data
Dec. 27, 2022 (JP) 2022-210818

(51) Int. Cl. G03G 21/16; G03G 15/08; G03G 21/18

(52) U.S. Cl. CPC G03G 21/1647; G03G 15/0868; G03G 15/0874; G03G 15/0886; G03G 21/1814; G03G 21/1821; G03G 2215/0678; G03G 2215/0682; G03G 2215/0692; G03G 2221/163

(57) ABSTRACT

A developer supply container includes a container unit and a discharge passage forming unit. The container unit includes a containing member including an opening portion, and a connecting member including an engaged portion and a connected portion connected to the opening portion of the containing member. The discharge passage forming unit includes an engaging portion configured to be engageable with the engaged portion, and a discharge passage which is configured to communicate with the accommodating space via the opening portion and through which the toner can be discharged to an outside.

### CROSS-REFERENCE TO RELATED APPLICATIONS

This application is a Continuation of International Patent Application No. PCT/JP2023/046733, filed Dec. 26, 2023, which claims the benefit of Japanese Patent Application No. 2022-210818, filed Dec. 27, 2022, both of which are hereby incorporated by reference herein in their entirety.

### BACKGROUND

### Field of the Technology

The present disclosure relates to a developer supply container for supplying developer to an image forming apparatus, a developer supply container set and a container unit each being usable as a developer supply container, and an image forming system that forms an image on a recording material.

### Description of the Related Art

Japanese Patent Laid-Open No. 2020-154300 describes that toner serving as developer is supplied from the outside of an image forming apparatus to a developer storage provided in an apparatus body of the image forming apparatus by attaching a supply container (a toner pack) into a supply port of the image forming apparatus. In the toner pack of the above-specified document, an easily-deformable plastic bag body containing toner therein, and a unit attached in a supply port to discharge the toner in the bag body to the supply port are integrated in advance.

In recent years, there has been a demand for image forming apparatuses (image forming systems) to be used in various ways.

### SUMMARY

According to the present disclosure, new embodiments can be provided for a developer supply container, a developer supply container set, a container unit, and an image forming system.

An aspect of the present disclosure provides a developer supply container including a container unit, and a discharge passage forming unit attached to the container unit, wherein the container unit includes a containing member configured to form an accommodating space in which toner is accommodated and including an opening portion communicating with the accommodating space, and a connecting member including a connected portion and an engaged portion, the connected portion being connected to the opening portion of the containing member, wherein the discharge passage forming unit includes an engaging portion configured to be engageable with the engaged portion, and a discharge passage which is configured to communicate with the accommodating space via the opening portion and through which the toner can be discharged to an outside, wherein the discharge passage forming unit is configured to be attachable to and detachable from the container unit in a direction in which the discharge passage forming unit and the container unit are to be aligned, by moving the discharge passage forming unit with respect to the container unit in the direction in which the discharge passage forming unit and the container unit are to be aligned, without rotating the discharge passage forming unit with respect to the container unit, and wherein the discharge passage forming unit is configured to be detached from the container unit in a case where an engagement of the engaging portion with the engaged portion is released.

Another aspect of the present disclosure provides a developer supply container set including a container unit, and a discharge passage forming unit, wherein the developer supply container set is usable as a developer supply container in a case where the discharge passage forming unit is attached to the container unit, wherein the container unit includes a containing member configured to form an accommodating space in which toner is accommodated and including an opening portion communicating with the accommodating space, a connecting member including a connected portion and an engaged portion, the connected portion being connected to the opening portion of the containing member, and a sealing member configured to seal the toner in the accommodating space by closing the opening portion, wherein the discharge passage forming unit includes an engaging portion configured to be engageable with the engaged portion, and a discharge passage which is configured to communicate with the accommodating space via the opening portion in a state where the discharge passage forming unit is attached to the container unit and through which the toner can be discharged to an outside, and wherein the discharge passage forming unit is configured to be attachable to and detachable from the container unit in a direction in which the discharge passage forming unit and the container unit are to be aligned, by moving the discharge passage forming unit with respect to the container unit in the direction in which the discharge passage forming unit and the container unit are to be aligned, without rotating the discharge passage forming unit with respect to the container unit, and wherein the discharge passage forming unit is configured to be detached from the container unit in a case where an engagement of the engaging portion with the engaged portion is released.

Still another aspect of the present disclosure provides a container unit usable as a developer supply container in a case where a discharge passage forming unit including an engaging portion is attached thereto, the container unit including a containing member configured to form an accommodating space in which toner is accommodated and including an opening portion communicating with the accommodating space, a connecting member including a connected portion and an engaged portion, the connected portion being connected to the opening portion of the containing member, the engaged portion being configured to be engageable with the engaging portion, and a sealing member configured to seal the toner in the accommodating space by closing the opening portion, wherein the container unit is configured such that, in a state where the discharge passage forming unit is attached the container unit, a discharge passage provided in the discharge passage forming unit communicates with the accommodating space via the opening portion so that the toner can be discharged to an outside via the discharge passage, wherein the container unit is configured such that the discharge passage forming unit is attachable to and detachable from the container unit in a direction in which the discharge passage forming unit and the container unit are to be aligned, by moving the discharge passage forming unit with respect to the container unit in the direction in which the discharge passage forming unit and the container unit are to be aligned, without rotating the discharge passage forming unit with respect to the container unit, and wherein the container unit is configured such that the discharge passage forming unit is detached from the container unit in a case where an engagement of the engaging portion with the engaged portion is released.

Still another aspect of the present disclosure provides a developer supply container set including a container unit, and a discharge passage forming unit, wherein the developer supply container set is usable as a developer supply container in a case where the discharge passage forming unit is attached to the container unit, wherein the container unit includes an engaged portion, a containing member configured to form an accommodating space in which toner is accommodated and including an opening portion communicating with the accommodating space, and a sealing member configured to seal the toner in the accommodating space by closing the opening portion, wherein the discharge passage forming unit includes an engaging portion configured to be engageable with the engaged portion, a discharge passage which is configured to communicate with the accommodating space in a state where the discharge passage forming unit is attached to the container unit and through which the toner can be discharged to an outside, and an unsealing means configured to release sealing of the toner by the sealing member so as to allow the accommodating space and the discharge passage to communicate with each other in a process of attaching the discharge passage forming unit to the container unit, wherein the discharge passage forming unit is configured to be attachable to and detachable from the container unit in a direction in which the discharge passage forming unit and the container unit are to be aligned, by moving the discharge passage forming unit with respect to the container unit in the direction in which the discharge passage forming unit and the container unit are to be aligned, without rotating the discharge passage forming unit with respect to the container unit, and wherein the discharge passage forming unit is configured to be detached from the container unit in a case where an engagement of the engaging portion with the engaged portion is released.

Features of the present disclosure will become apparent from the following description of embodiments with reference to the attached drawings.

### BRIEF DESCRIPTION OF THE DRAWINGS

FIG. 1A is a schematic view illustrating an image forming apparatus according to Example 1.

FIG. 1B is a perspective view illustrating the image forming apparatus according to Example 1.

FIG. 2 is a perspective view illustrating an opening/closing member and a supply port.

FIG. 3A is an exploded perspective view of an attaching part.

FIG. 3B is an exploded perspective view of the attaching part as viewed from a direction different from that in FIG. 3A.

FIG. 4A is a perspective view illustrating an appearance of the attaching part when an operation lever is located at a closed position.

FIG. 4B is a perspective view illustrating an appearance of the attaching part when the operation lever is located at an opened position.

FIG. 5A is a plan view illustrating an appearance of the attaching part when the operation lever is located at the closed position.

FIG. 5B is a plan view illustrating an appearance of the attaching part when the operation lever is located at the opened position.

FIG. 6A is a perspective view of an apparatus-side shutter as viewed from an upstream side in an attaching direction.

FIG. 6B is a perspective view of the apparatus-side shutter as viewed from a viewpoint different from that in FIG. 6A.

FIG. 7A is a perspective view of a cover as viewed from a downstream side in the attaching direction.

FIG. 7B is a perspective view of the cover as viewed from the upstream side in the attaching direction.

FIG. 8A is a cross-sectional view illustrating the attaching part.

FIG. 8B is a cross-sectional view illustrating a cross section taken along line 8B-8B in FIG. 8A.

FIG. 9A is a side view of a toner pack when the pack-side shutter is located at a shielding position.

FIG. 9B is a side view of the toner pack when the pack-side shutter is located at an opening position.

FIG. 10 is an exploded perspective view illustrating the toner pack when the pack-side shutter is located at the shielding position.

FIG. 11A is an enlarged perspective view illustrating the vicinity of a nozzle when the pack-side shutter is located at the shielding position.

FIG. 11B is a view of the toner pack in a detaching direction.

FIG. 12A is an enlarged perspective view illustrating the vicinity of the nozzle when the pack-side shutter is located at the opening position.

FIG. 12B is a view of the toner pack in the detaching direction.

FIG. 13 is an enlarged perspective view illustrating the vicinity of the nozzle.

FIG. 14 is a side view illustrating the nozzle and the pack-side shutter.

FIG. 15A is a front view illustrating a claw portion.

FIG. 15B is a cross-sectional view illustrating a cross section taken along line 15B-15B in FIG. 15A.

FIG. 16A is a front view illustrating the claw portion.

FIG. 16B is a cross-sectional view illustrating a cross section taken along line 16B-16B in FIG. 16A.

FIG. 17A is a perspective view illustrating a state in which the toner pack is being attached to the attaching part.

FIG. 17B is a perspective view illustrating a state in which the toner pack is being attached to the attaching part as viewed from another angle.

FIG. 18A is a cross-sectional view illustrating a state when the toner pack is being attached toward the attaching part.

FIG. 18B is a cross-sectional view illustrating a state in which the toner pack has been attached to the attaching part.

FIG. 19A is a cross-sectional view illustrating a cross section taken along line 19A-19A in FIG. 18A.

FIG. 19B is a cross-sectional view illustrating a cross section taken along line 19B-19B in FIG. 18A.

FIG. 20A is a cross-sectional view illustrating a cross section taken along line 20A-20A in FIG. 18B.

FIG. 20B is a cross-sectional view illustrating a cross section taken along line 20B-20B in FIG. 20A.

FIG. 21A is a perspective view illustrating a state when the toner pack is being attached to the apparatus-side shutter.

FIG. 21B is a cross-sectional view illustrating a cross section taken along line 15B-15B in FIG. 15A in a state where the toner pack has been attached to the attaching part.

FIG. 22A is a perspective view illustrating the operation lever and the toner pack located at the closed position.

FIG. 22B is a perspective view illustrating the operation lever and the toner pack located at the opened position.

FIG. 23A is a cross-sectional view illustrating the toner pack and the attaching part when both the apparatus-side shutter and the pack-side shutter are located at the shielding position.

FIG. 23B is a cross-sectional view illustrating the toner pack and the attaching part when both the apparatus-side shutter and the pack-side shutter are located at the opening position.

FIG. 24A is a perspective view of the nozzle according to Example 1.

FIG. 24B is a perspective view of the nozzle according to Example 1 as viewed from a viewpoint different from that in FIG. 24A.

FIG. 25A is a view of the nozzle according to Example 1 as viewed from a pouch side.

FIG. 25B is a view of the nozzle according to Example 1 as viewed from the side opposite to the pouch.

FIG. 26A is a perspective view of a connecting member according to Example 1.

FIG. 26B is a perspective view of the connecting member according to Example 1 as viewed from a viewpoint different from that in FIG. 26A.

FIG. 27A is a perspective view illustrating a state before a connecting member is connected to the pouch.

FIG. 27B is a perspective view illustrating a state after the connecting member is connected to the pouch.

FIG. 27C is a perspective view illustrating a state after the connecting member and the nozzle are connected to the pouch.

FIG. 28A is a perspective cross-sectional view of the periphery of the nozzle in a pouch/nozzle assembly, and is a cross-sectional view taken along line 28A-28A in FIG. 28B.

FIG. 28B is a cross-sectional view illustrating a configuration of a seal member, and is a cross-sectional view taken along line 28B-28B in FIG. 28A.

FIG. 29 is an exploded perspective view of a pouch unit according to Example 1.

FIG. 30A is a side view of the toner pack according to Example 1 before being assembled.

FIG. 30B is a side view of the toner pack according to Example 1 while being assembled.

FIG. 30C is a side view illustrating the toner pack according to Example 1 after being assembled.

FIG. 31A is a cross-sectional view of the toner pack according to Example 1 before being assembled.

FIG. 31B is a partially enlarged view of FIG. 31A.

FIG. 31C is a cross-sectional view illustrating the toner pack according to Example 1 after being assembled.

FIG. 31D is a partially enlarged view of FIG. 31C.

FIG. 32A is a perspective view illustrating the pouch unit before a developer seal is torn according to Example 1.

FIG. 32B is a perspective view illustrating the pouch unit after the developer seal is torn according to Example 1.

FIG. 33 is a perspective view of a nozzle of a toner pack according to Example 2.

FIG. 34 is a perspective view of a connecting member of the toner pack according to Example 2.

FIG. 35 is an exploded perspective view of a pouch unit according to Example 2.

FIG. 36A is a cross-sectional view and a partially enlarged view for explaining a procedure of assembling the toner pack according to Example 2.

FIG. 36B is a cross-sectional view and a partially enlarged view for explaining a procedure of assembling the toner pack according to Example 2.

FIG. 36C is a cross-sectional view and a partially enlarged view for explaining a procedure of assembling the toner pack according to Example 2.

FIG. 36D is a cross-sectional view and a partially enlarged view for explaining a procedure of assembling the toner pack according to Example 2.

FIG. 37 is an exploded perspective view of a bottle unit according to Example 3.

FIG. 38 is a perspective view of the periphery of an opening portion of a bottle of the bottle unit according to Example 3.

FIG. 39A is a side view of the toner pack according to Example 3 before being assembled.

FIG. 39B is a side view of the toner pack according to Example 3 while being assembled.

FIG. 39C is a side view illustrating the toner pack according to Example 3 after being assembled.

FIG. 40A is a cross-sectional view of the toner pack according to Example 3 before being assembled.

FIG. 40B is a partially enlarged view of FIG. 40A.

FIG. 40C is a cross-sectional view illustrating the toner pack according to Example 3 after being assembled.

FIG. 40D is a partially enlarged view of FIG. 40C.

### DESCRIPTION OF THE EMBODIMENTS

Hereinafter, embodiments according to the present disclosure will be described with reference to the drawings.

### Example 1

An image forming apparatus according to Example 1 of the present disclosure will be described with reference to the drawings. The image forming apparatus of the present example is an electrophotographic image forming apparatus that forms an image on a recording material (recording medium) by an electrophotographic process. Examples of image forming apparatuses include a copying machine, a facsimile machine, a printer (a laser beam printer, an LED printer, etc.), and a multifunction peripheral (a multi-function printer) having the functions of these apparatuses.

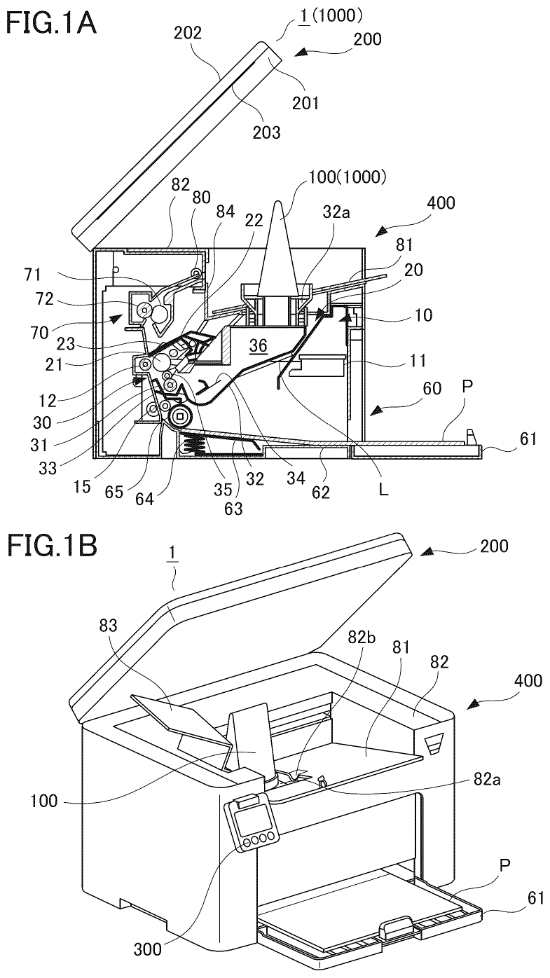

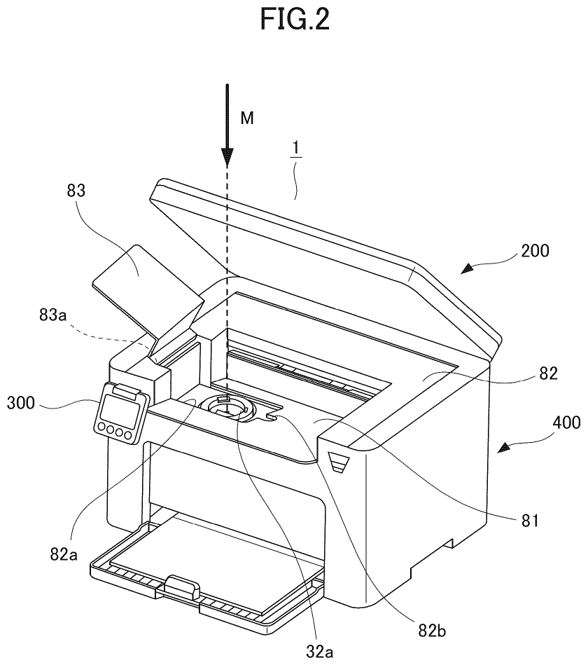

FIG. 1A is a schematic diagram illustrating a configuration of an image forming apparatus 1 according to the present example. FIG. 1B is a perspective view illustrating a configuration of the image forming apparatus 1. FIG. 2 is a perspective view illustrating an opening/closing member 83 and a supply port 32a.

The image forming apparatus 1 is a monochrome printer that forms an image on a recording material P based on image information input from an external device. The recording material P includes various sheet materials having different material properties, e.g., paper such as plain paper and thick paper, plastic films such as sheets for overhead projectors, sheets having special shapes such as envelopes and index paper, and cloth.

### Overall Configuration

As illustrated in FIGS. 1A and 1B, the image forming apparatus 1 includes an apparatus body 400, a reading device 200 supported by the apparatus body 400 in an openable and closable manner, and an operation unit 300 attached to an exterior surface of the apparatus body 400. The apparatus body 400 includes an image forming unit 10 that forms a toner image on a recording material, a feeding unit 60 that feeds the recording material to the image forming unit 10, a fixing unit 70 that fixes the toner image formed by the image forming unit 10 onto the recording material, and a sheet discharge roller pair 80.

The image forming unit 10 includes a scanner unit 11, an electrophotographic process unit 20, and a transfer roller 12 that transfers a toner image formed on a photosensitive drum 21 of the process unit 20 to a recording material. The process unit 20 includes a photosensitive drum 21, a charging roller 22 disposed around the photosensitive drum 21, a pre-exposing unit 23, and a developing unit 30 including a developing roller 31.

The photosensitive drum 21 is a photosensitive member molded in a cylindrical shape. The photosensitive drum 21 of the present example has a photosensitive layer formed of a negatively charged organic photosensitive member on a drum-shaped substrate molded from aluminum. In addition, the photosensitive drum 21 is driven to be rotated at a predetermined process speed in a predetermined direction (clockwise direction in the drawings) by a motor.

The charging roller 22 is in contact with the photosensitive drum 21 with a predetermined pressure contact force to form a charging portion. In addition, a desired charging voltage is applied to the charging roller 22 by a charging high-voltage power supply, thereby uniformly charging a surface of the photosensitive drum 21 to a predetermined potential. In the present example, the photosensitive drum 21 is negatively charged by the charging roller 22. The pre-exposing unit 23 neutralizes the surface potential of the photosensitive drum 21 at a position in front of the charging portion in order to generate a stable discharge in the charging portion.

The scanner unit 11 scans and exposes the surface of the photosensitive drum 21 by irradiating the photosensitive drum 21 with laser light corresponding to image information input from the external device or the reading device 200 using a polygon mirror. By this exposure, an electrostatic latent image corresponding to the image information is formed on the surface of the photosensitive drum 21. Note that the scanner unit 11 is not limited to the laser scanner device, and for example, an LED exposing unit having an LED array in which a plurality of LEDs are arranged along the longitudinal direction of the photosensitive drum 21 may be adopted.

The developing unit 30 includes a developing roller 31 that bears developer, a developing container 32 that serves as a case of the developing unit 30, and a supplying roller 33 that can supply the developer to the developing roller 31. The developing roller 31 and the supplying roller 33 are rotatably supported by the developing container 32. In addition, the developing roller 31 is disposed in an opening portion of the developing container 32 to face the photosensitive drum 21. The supplying roller 33 rotatably abuts on the developing roller 31, and a toner contained in the developing container 32 is applied onto the surface of the developing roller 31 by the supplying roller 33. Note that the supplying roller 33 is not necessarily required as long as the toner can be sufficiently supplied to the developing roller 31.

The developing unit 30 of the present example uses a contact developing method as a developing method. That is, a toner layer borne on the developing roller 31 comes into contact with the photosensitive drum 21 in a developing portion (a developing region) where the photosensitive drum 21 and the developing roller 31 face each other. A developing voltage is applied to the developing roller 31 by a developing high-voltage power supply. Under the developing voltage, the toner borne on the developing roller 31 is transferred from the developing roller 31 to the drum surface according to a potential distribution on the surface of the photosensitive drum 21, thereby developing an electrostatic latent image into a toner image. Note that, in the present example, a reversal development system is adopted. That is, the toner image is formed by the toner adhering to the surface region of the photosensitive drum 21 where the charge amount is attenuated when the surface region of the photosensitive drum 21 is exposed in the exposure step after being charged in the charging step.

In the present example, toner having a particle size of 6 (um) with its normal charging polarity being a negative polarity is used. As the toner of the present example, a polymerized toner generated by a polymerization method is employed as an example. In addition, the toner of the present example does not contain a magnetic component, and is a so-called non-magnetic one-component developer borne on the developing roller 31 mainly by intermolecular force or electrostatic force (mirror-image force). However, a one-component developer containing a magnetic component may be used. The one-component developer may contain an additive (e.g., wax or silica fine particles) for adjusting fluidity and charging performance of the toner in addition to the toner particles. As the developer, a two-component developer composed of a non-magnetic toner and a magnetic carrier may be used. When a magnetic developer is used, for example, a cylindrical developing sleeve in which a magnet is disposed is used as a developer bearing member.

The developing container 32 is provided with a storage 36 that stores toner and a stirring member 34 disposed inside the storage 36. The developing container 32 is an example of a developer storage that stores developer inside the image forming apparatus 1. The stirring member 34 is driven by a motor (not illustrated) to pivot, thereby stirring the toner in the developing container 32 and sending the toner toward the developing roller 31 and the supplying roller 33. In addition, the stirring member 34 has a function of circulating the toner not used for development but peeled off from the developing roller 31 in the developing container to make the toner in the developing container uniform. Note that the stirring member 34 is not limited to the pivoting type. For example, a swing-type stirring member may be employed.

In addition, a developing blade 35 that regulates the amount of toner borne on the developing roller 31 is disposed in the opening portion of the developing container 32 where the developing roller 31 is disposed. The toner supplied to the surface of the developing roller 31 is uniformly thinned when passing through a portion where the developing roller 31 and the developing blade 35 face each other as the developing roller 31 is rotating, and is charged to a negative polarity by frictional charging.

As illustrated in FIGS. 1A and 1B, the feeding unit 60 includes a front door 61 supported by the apparatus body 400 in an openable and closable manner, a tray portion 62, a middle plate 63, a tray spring 64, and a pickup roller 65. The tray portion 62 constitutes a bottom surface of a recording material storage space appearing when the front door 61 is opened, and the middle plate 63 is supported by the tray portion 62 in a vertically movable manner. The tray spring 64 biases the middle plate 63 upward, and presses the recording material P stacked on the middle plate 63 against the pickup roller 65. Note that the front door 61 closes the recording material storage space when closed with respect to the apparatus body 400, and supports the recording material P together with the tray portion 62 and the middle plate 63 when opened with respect to the apparatus body 400.

The fixing unit 70 is of a thermal fixing type in which image fixing processing is performed by heating and melting the toner on the recording material. The fixing unit 70 includes a fixing film 71, a fixing heater such as a ceramic heater that heats the fixing film 71, a thermistor that measures the temperature of the fixing heater, and a pressurizing roller 72 that comes into pressure contact with the fixing film 71.

Next, an image forming operation of the image forming apparatus 1 will be described. When an image forming command is input to the image forming apparatus 1, an image forming process is started by the image forming unit 10 based on image information input from an external computer connected to the image forming apparatus 1 or the reading device 200. The scanner unit 11 irradiates the photosensitive drum 21 with laser light based on the input image information. At this time, the photosensitive drum 21 is charged in advance by the charging roller 22, and an electrostatic latent image is formed on the photosensitive drum 21 when irradiated with laser light. Thereafter, the electrostatic latent image is developed by the developing roller 31, and a toner image is formed on the photosensitive drum 21.

In parallel with the above-described image forming process, the pickup roller 65 of the feeding unit 60 feeds the recording material P supported by the front door 61, the tray portion 62, and the middle plate 63. The recording material P is fed to a registration roller pair 15 by the pickup roller 65, and abuts against the nip of the registration roller pair 15 to correct skew feeding. Then, the registration roller pair 15 is driven in synchronization with the timing at which the toner image is transferred, and conveys the recording material P toward a transfer nip formed by the transfer roller 12 and the photosensitive drum 21.

A transfer voltage is applied to the transfer roller 12 from a transferring high-voltage power supply, and the toner image borne on the photosensitive drum 21 is transferred to the recording material P conveyed by the registration roller pair 15. The recording material P to which the toner image has been transferred is conveyed to the fixing unit 70, and the toner image is heated and pressurized when passing through a nip portion between the fixing film 71 and the pressurizing roller 72 of the fixing unit 70. As a result, the toner particles are melted and then fixed, whereby the toner image is fixed to the recording material P. The recording material P having passed through the fixing unit 70 is discharged to the outside (outside the machine) of the image forming apparatus 1 by the sheet discharge roller pair 80, and is stacked on a sheet discharge tray 81 formed in an upper portion of the apparatus body 400.

The sheet discharge tray 81 is inclined upward and downstream in the recording material discharging direction, and the recording material discharged to the sheet discharge tray 81 slides down on the sheet discharge tray 81, so that the trailing edge of the recording material is aligned by a restricting surface 84.

The reading device 200 includes a reading unit 201 incorporating a reading part (not illustrated) therein, and a pressure plate 202 supported by the reading unit 201 in an openable and closable manner. On the upper surface of the reading unit 201, there is provided a platen glass 203 which transmits light emitted from the reading part and on which a document is placed.

When an image of a document is to be read by the reading device 200, the user places the document on the platen glass 203 in a state where the pressure plate 202 is opened. Then, the pressure plate 202 is closed to prevent the document from being misaligned on the platen glass 203, and a reading command is output to the image forming apparatus 1, for example, by operating the operation unit 300. When a reading operation is started, the reading part in the reading unit 201 reciprocates in the sub-scanning direction, that is, in the left-right direction in a state where the reading part faces forward the operation unit 300 of the image forming apparatus 1. The reading part reads the image of the document, while light is emitted from a light emitting part to the document, and the light reflected by the document is received by a light receiving part and photoelectrically converted. Hereinafter, the front-back direction, the left-right direction, and the up-down direction are defined based on the state in which the reading part faces forward the operation unit 300.

A top cover 82 is provided in an upper portion of the apparatus body 400, and the sheet discharge tray 81 is formed on an upper surface of the top cover 82. As illustrated in FIGS. 1B and 2, the opening/closing member 83 is supported on the top cover 82 in such a manner as to be openable and closable about a pivot shaft 83a extending in the front-rear direction. An opening portion 82a open upward is formed in the sheet discharge tray 81 of the top cover 82.

The opening/closing member 83 is configured to be movable between a closed position, where the supply port 32a is closed so that a toner pack 100 serving as a developer supply container cannot be attached in the developing container 32, and an opened position, where the supply port 32a is exposed so that the toner pack 100 can be attached in the developing container 32. The toner pack 100 is moved in an attaching direction M toward the supply port 32a in a state where the opening/closing member 83 is located at the opened position, and is attached into the supply port 32a.

The opening/closing member 83 functions as a part of the sheet discharge tray 81 at the closed position. The opening/closing member 83 and the opening portion 82a are formed on the left side of the sheet discharge tray 81. In addition, the opening/closing member 83 is opened in the left direction by hooking a finger from a groove portion 82b provided in the top cover 82. The opening/closing member 83 is formed in a substantially L shape along the shape of the top cover 82.

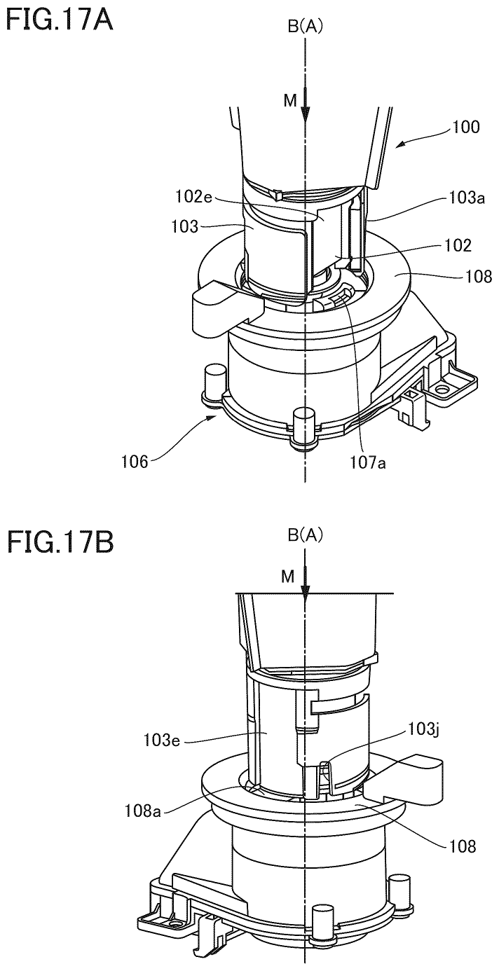

The opening portion 82a of the sheet discharge tray 81 is open such that the supply port 32a for supplying toner formed in the upper portion of the developing container 32 is exposed, and the user can access the supply port 32a by opening the opening/closing member 83. In the present example, a method (direct supply method) is adopted in which, while the developing unit 30 is mounted in the image forming apparatus 1, the user supplies toner to the developing unit 30 from the toner pack 100 (see FIGS. 1A and 1B) filled with the toner to be supplied. At least a part of the toner pack 100 is exposed to the outside in a state where the toner pack 100 is attached in an attaching part 106 (see FIGS. 17A and 17B) of the image forming apparatus 1.

Therefore, when the remaining amount of the toner in the process unit 20 becomes low, it is not necessary to take out the process unit 20 from the apparatus body 400 and replace the process unit 20 with a new one, making it possible to improve usability. In addition, it is possible to supply toner to the developing container 32 at a cost lower than that in a case where the entire process unit 20 is replaced. The direct supply method can reduce the cost when compared with even a case where only the developing unit 30 of the process unit 20 is replaced, because it is not necessary to replace various rollers, gears, and the like. The image forming apparatus 1 and the toner pack 100 constitute an image forming system 1000.

### Attaching Part

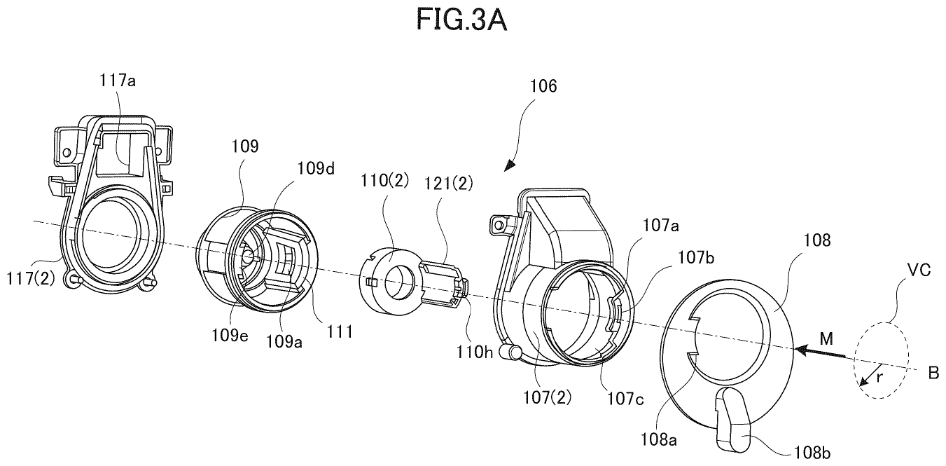

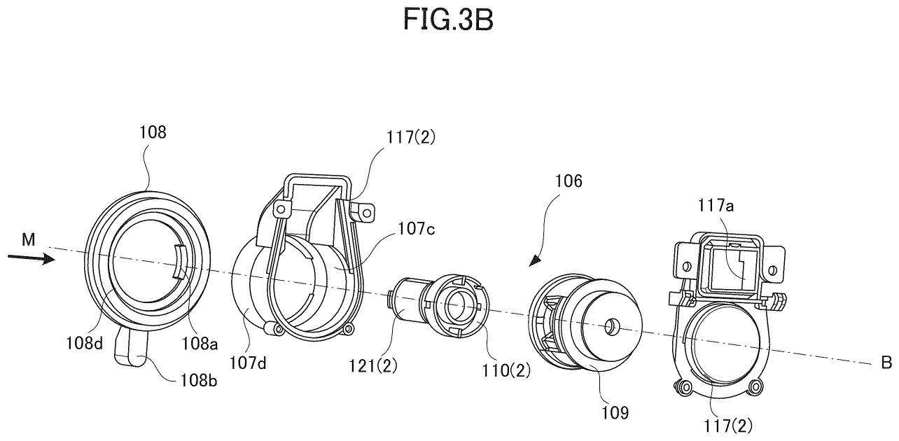

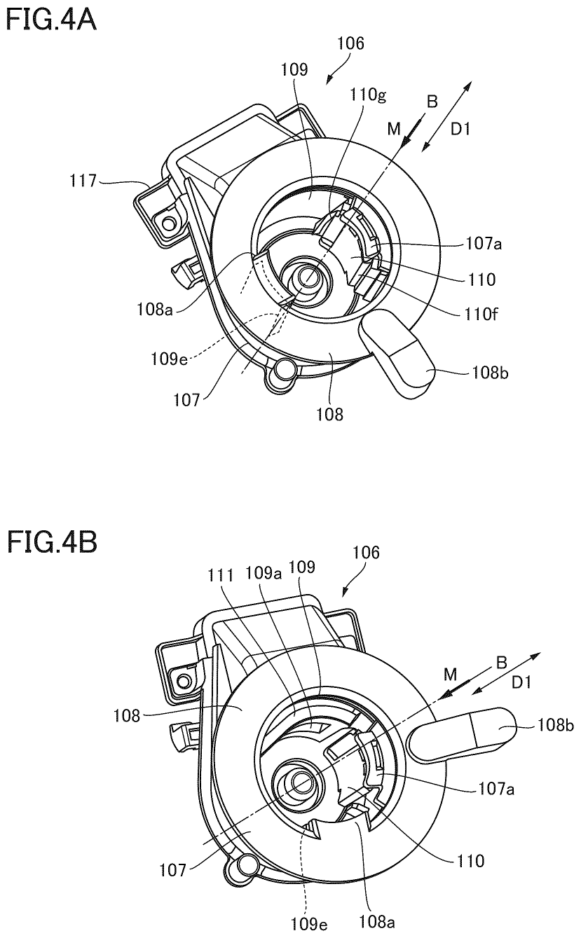

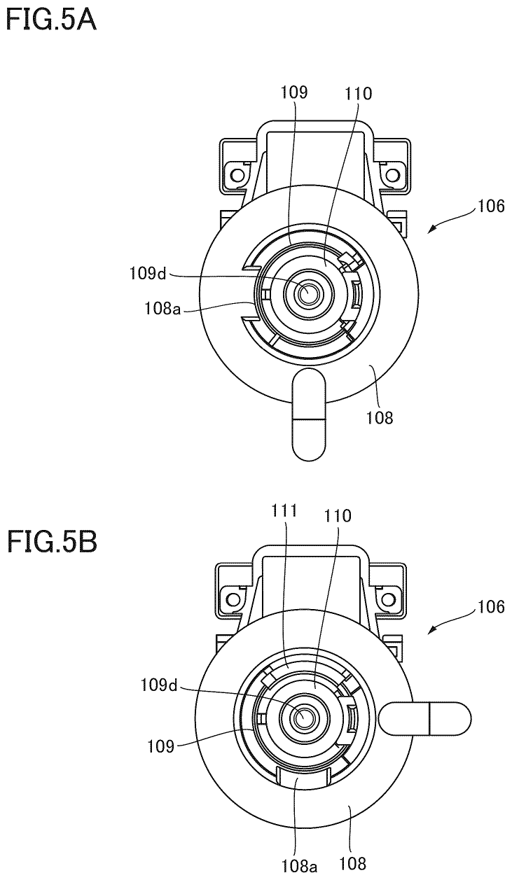

Next, the configuration of the attaching part 106 to which the toner pack 100 is attached will be described with reference to FIGS. 3A to 8B. In the present example, the attaching part 106 is a unit for attaching the toner pack 100, including the supply port 32a, and is provided in the image forming apparatus 1 (see FIG. 2). FIG. 3A is an exploded perspective view of the attaching part 106. FIG. 3B is an exploded perspective view of the attaching part 106 as viewed from a direction different from that in FIG. 3A. FIG. 4A is a perspective view illustrating the appearance of the attaching part 106 when an operation lever 108 is located at the closed position, and FIG. 5A is a view of the attaching part 106 as viewed from the attaching direction M when the operation lever 108 is located at the closed position. FIG. 4B is a perspective view illustrating the appearance of the attaching part 106 when the operation lever 108 is located at the opened position, and FIG. 5B is a view of the attaching part 106 as viewed from the attaching direction M when the operation lever 108 is located at the opened position.

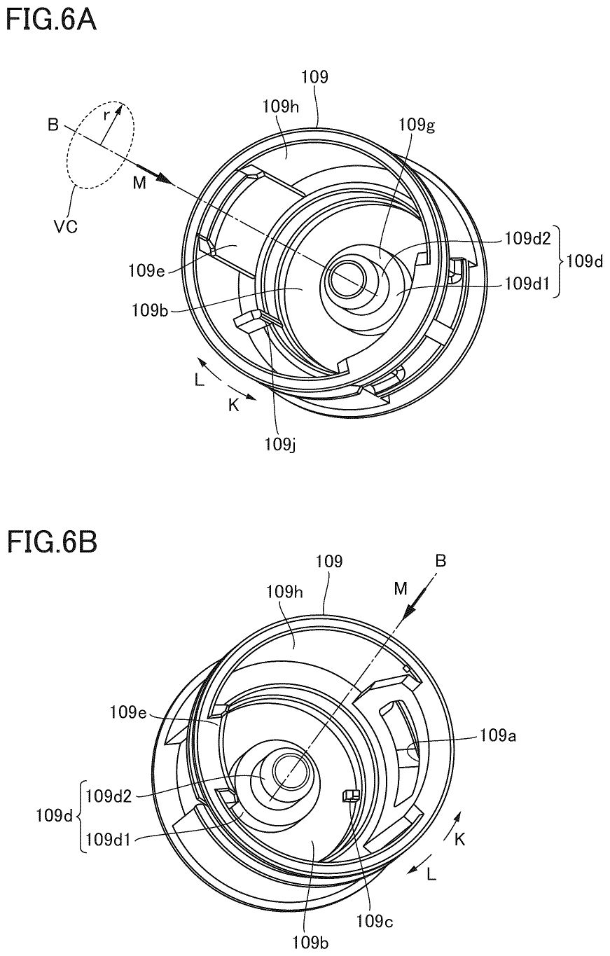

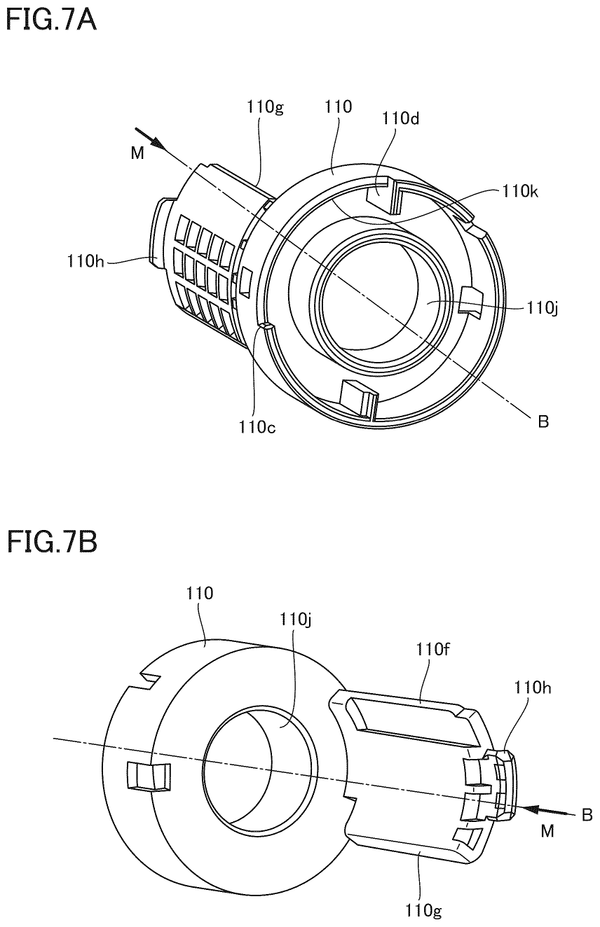

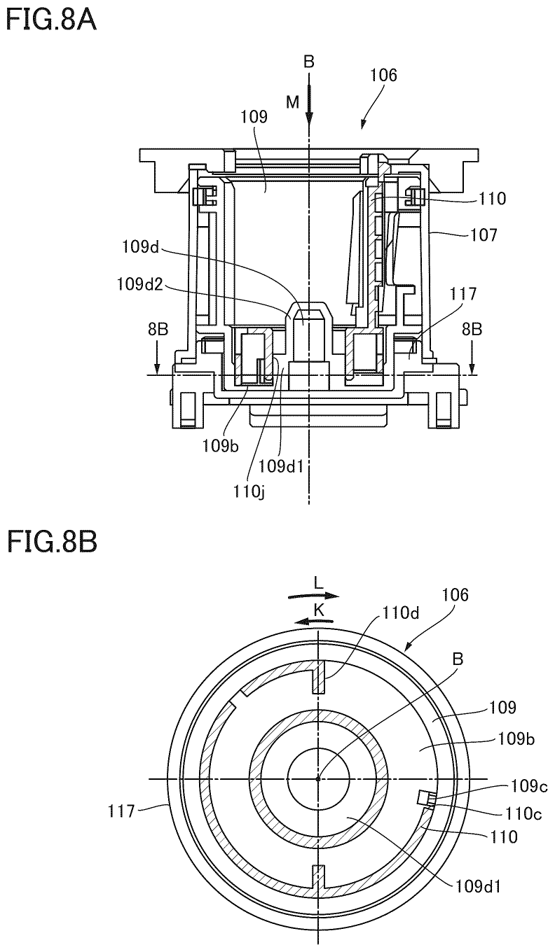

FIG. 6A is a perspective view of an apparatus-side shutter 109 as viewed from the upstream side in the attaching direction M. FIG. 6B is a perspective view of the apparatus-side shutter 109 from a viewpoint different from that in FIG. 6A. FIG. 7A is a perspective view of a cover 110 as viewed from the downstream side in the attaching direction M. FIG. 7B is a perspective view of the cover 110 as viewed from the upstream side in the attaching direction M. FIG. 8A is a cross-sectional view illustrating the attaching part 106, and FIG. 8B is a cross-sectional view illustrating a cross section taken along line 8B-8B in FIG. 8A.

As illustrated in FIGS. 3A to 4B, the attaching part 106 includes a main body base part 2, and the main body base part 2 includes a first frame body 107, a second frame body 117, and a cover 110. The cover 110 and the second frame body 117 are fixed to the first frame body 107. As illustrated in FIGS. 7A and 7B, the cover 110 includes an engaged portion 110h that is engaged with an engaging portion 107b of a positioning portion 107a of the first frame body 107 not to rotate about a rotation axis B with respect to the first frame body 107. Further, a notch 110k is provided on the downstream side, that is, the bottom surface side, of the cover 110 in the attaching direction M, and the notch 110k has a first restricting surface 110c and a second restricting surface 110d. The first restricting surface 110c and the second restricting surface 110d are provided to face each other in the circumferential direction with the rotation axis B as the center.

The first frame body 107, the cover 110, and the second frame body 117 may be integrally formed, rather than being separate members. As illustrated in FIGS. 3A and 3B, the second frame body 117 has an apparatus-side opening 117a, and the apparatus-side opening 117a communicates with the storage 36 (see FIG. 1A) of the developing container 32.

Each of the operation lever 108 and the apparatus-side shutter 109 is attached to the main body base part 2 so as to be rotatable about the rotation axis B. The first frame body 107 has a positioning portion 107a. The positioning portion 107a protrudes inward from an inner peripheral surface 107c of the first frame body 107 with the rotation axis B as the center in a radial direction r of a virtual circle VC with the rotation axis B as the center.

In addition, the operation lever 108 serving as an operation part has a driving transmission portion 108a and an operation portion 108b. The user can rotate the operation lever 108 about the rotation axis B with respect to the main body base part 2 by operating the operation portion 108b. As illustrated in FIG. 3A, the driving transmission portion 108a is a protrusion protruding inward from an inner peripheral surface of the operation lever 108 with the rotation axis B as the center in the radial direction r of the virtual circle VC with the rotation axis B as the center.

As illustrated in FIGS. 6A and 6B, the apparatus-side shutter 109 serving as a main body shutter includes an inner peripheral surface 109h, a receiving port 109a formed in the inner peripheral surface 109h to receive toner from the toner pack 100, and a bottom surface 109b. The apparatus-side shutter 109 further includes a center boss 109d provided on the bottom surface 109b, a pack abutment surface 109g, a restricted rib 109c, and a driven transmission portion 109e provided on the inner peripheral surface 109h. As illustrated in FIG. 6A, the driven transmission portion 109e is a protrusion protruding inward in the radial direction r of the virtual circle VC with the rotation axis B as the center. An apparatus-side seal 111 is attached to the inner peripheral surface 109h so as to surround the periphery of the receiving port 109a (see FIG. 4B).

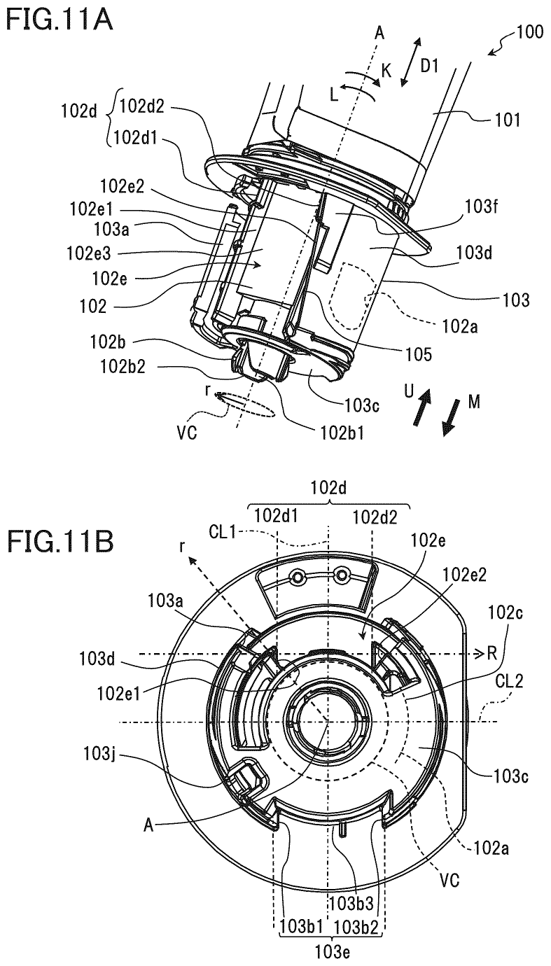

The apparatus-side shutter 109 is configured to take a shielding position and an opening position with respect to the main body base part 2. More specifically, as illustrated in FIGS. 6A and 6B, the apparatus-side shutter 109 rotates in a direction indicated by arrow K from the shielding position toward the opening position, and rotates in a direction indicated by arrow L from the opening position toward the shielding position. Note that the direction indicated by arrow K and the direction indicated by arrow L are similar to a direction indicated by arrow K and a direction indicated by arrow L of a pack-side shutter 103 illustrated in FIG. 11A. When the apparatus-side shutter 109 is located at the shielding position, the receiving port 109a is shielded by the apparatus-side seal 111 and the cover 110. When the apparatus-side shutter 109 is located at the opening position, the receiving port 109a is not covered by the cover 110 but open. That is, the receiving port 109a does not communicate with the apparatus-side opening 117a of the second frame body 117 when the apparatus-side shutter 109 is located at the shielding position, and communicates with the apparatus-side opening 117a of the second frame body 117 when the apparatus-side shutter 109 is located at the opening position.

In FIGS. 4A and 5A, the apparatus-side shutter 109 is located at the shielding position, and at this time, the receiving port 109a of the apparatus-side shutter 109 does not communicate with the apparatus-side opening 117a of the second frame body 117. In addition, in FIGS. 4B and 5B, the apparatus-side shutter 109 is located at the opening position, and at this time, the receiving port 109a of the apparatus-side shutter 109 communicates with the apparatus-side opening 117a of the second frame body 117. When the apparatus-side shutter 109 moves to the opening position, the toner can be supplied (replenished) from the toner pack 100 to the storage 36 of the developing container 32 via the receiving port 109a.

Since the operation lever 108 and the apparatus-side shutter 109 are not connected to each other in drive, the apparatus-side shutter 109 does not rotate even if the operation lever 108 is operated in a state where the toner pack 100 is not attached.

As illustrated in FIGS. 8A and 8B, the apparatus-side shutter 109 is configured to be rotatable about the center boss 109d by engaging a large-diameter portion 109d1 of the center boss 109d with a cylindrical portion 110j of the cover 110. Here, the restricted rib 109c provided on the bottom surface 109b of the apparatus-side shutter 109 is located between the first restricting surface 110c and the second restricting surface 110d of the cover 110. Thus, the apparatus-side shutter 109 is rotatable only within a range in which the restricted rib 109c is movable between the first restricting surface 110c and the second restricting surface 110d. In other words, the rotation range of the apparatus-side shutter 109 is restricted between the shielding position and the opening position by the first restricting surface 110c and the second restricting surface 110d of the cover 110. For example, as illustrated in FIG. 8B, in a state where the restricted rib 109c abuts on the first restricting surface 110c, the apparatus-side shutter 109 located at the shielding position cannot rotate in the direction indicated by arrow L, that is, in a direction opposite to the direction toward the opening position.

### Configuration of Toner Pack

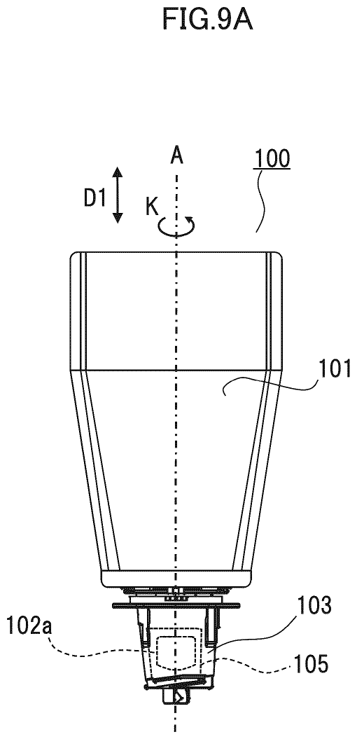

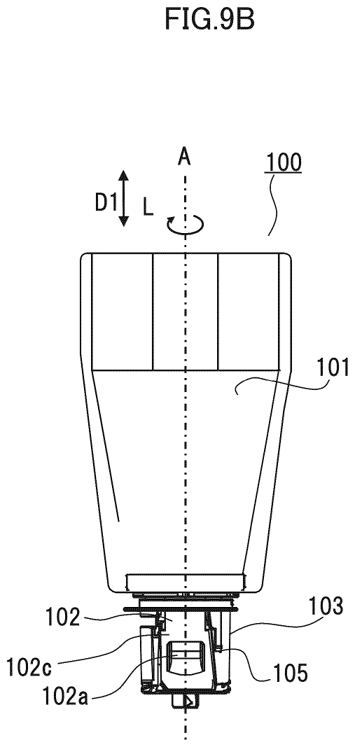

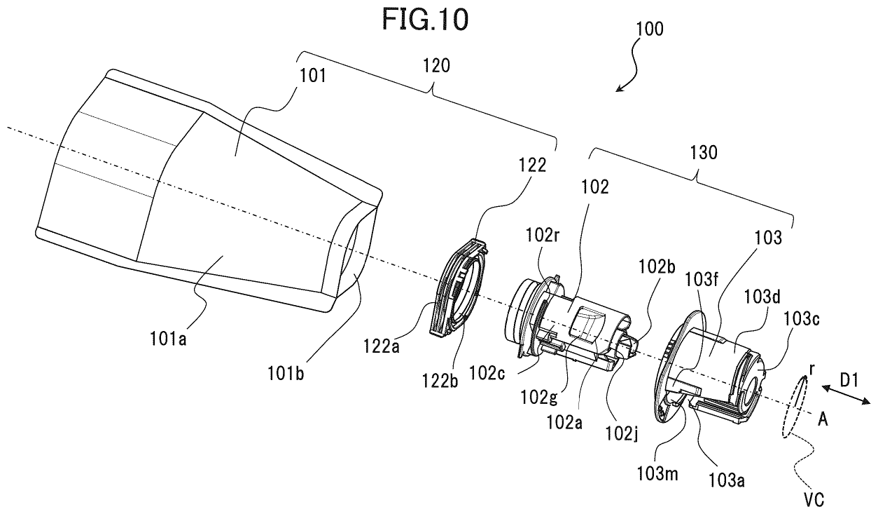

Next, a basic configuration of the toner pack 100 serving as a developer supply container according to the present example will be described with reference to FIGS. 9A to 10. The toner pack 100 is attached to the attaching part 106 described above. FIG. 9A is a side view of the toner pack 100 when the pack-side shutter 103 is located at the shielding position. FIG. 9B is a side view of the toner pack 100 when the pack-side shutter 103 is located at the opening position. FIG. 10 is an exploded perspective view illustrating the toner pack 100 when the pack-side shutter 103 is located at the opening position.

As illustrated in FIGS. 9A to 10, the toner pack 100 includes a pouch 101 that accommodates toner serving as developer, a connecting member 122 (FIG. 10) connected to the pouch 101, a nozzle 102 connected to the connecting member 122, and a pack-side shutter 103.

The pouch 101 and the connecting member 122 form a pouch unit 120 serving as a container unit (supply container main body) of the toner pack 100. The nozzle 102 and the pack-side shutter 103 form a nozzle unit 130 (nozzle-shutter assembly) serving as a discharge passage forming unit of the toner pack 100. That is, the toner pack 100 of the present example includes the pouch unit 120 and the nozzle unit 130.

The pouch unit 120 is a portion that mainly accommodates the contents (the toner in the present example) of the supply container. The nozzle unit 130 is a portion attached to the attaching part 106 of the image forming apparatus 1. As will be described below, the toner pack 100 in which the nozzle unit 130 and the pouch unit 120 are integrated is formed by engaging an engaging portion of the nozzle 102 with an engaged portion of the connecting member 122.

The pouch 101 serving as a containing member (accommodating member) has flexibility, and is provided on one end side of the toner pack 100 in an axial direction D1 that is a direction along a rotation axis A of the pack-side shutter 103. The term “flexibility” means that the pouch 101 has flexibility to such an extent that the user can easily deform the pouch 101 by hand to reduce its volume.

When the toner pack 100 is attached to the attaching part 106, the rotation axis A coincides with the rotation axis B of the apparatus-side shutter 109. Therefore, both the axial directions of the rotation axis A and the rotation axis B will hereinafter be referred to as the axial direction D1. The nozzle 102 and the pack-side shutter 103 are provided on the other end side of the toner pack 100 in the axial direction D1. The pouch 101 is formed, for example, by processing flexible polypropylene sheets into a pouch (joining peripheral edges of stacked synthetic resin sheets by welding or the like), and has a shape like a bag with one end being opened.

The material of the containing member is not limited to the polypropylene sheet, but may be paper, vinyl, or the like. The shape of the containing member is not limited to the flat bag shape (pouch shape) formed by the pouch processing, and may be, for example, a cylindrical shape (bottle shape) or a rectangular parallelepiped shape.

The pouch 101 includes an accommodating portion 101a forming an accommodating space for accommodating the toner, and an opening portion 101b where the accommodating space is open. The opening portion 101b is an opening edge of the accommodating portion 101a. The opening portion 101b of the present example is an end on one side of the accommodating portion 101a in the axial direction D1. The accommodating portion 101a has a bag shape having a side surface portion in a flat cylindrical shape extending in the axial direction D1 and a bottom portion closing one side (a side opposite to the opening portion 101b) of the cylindrical shape.

The connecting member 122 (joining member) is connected (joined) to the opening portion 101b of the pouch 101. That is, the connecting member 122 is integrated with the pouch 101 serving as a containing member in advance, and constitutes the pouch unit 120 together with the pouch 101. The method of connecting (joining) the connecting member 122 and the pouch 101 is not limited to a specific method. For example, there are a method using various adhesives such as hot melt (adhesion), a method in which the pouch 101 is thermally welded to the outer periphery of the connecting member 122, and the like. Further, the connecting member 122 may be made up of a plurality of parts.

In the present example, the connecting member 122 is harder than the pouch 101 having flexibility. That is, while the pouch 101 is formed of a material soft enough to be easily deformed by the user's hand, the connecting member 122 can maintain the opening portion 101b of the pouch 101 in a constant shape, contributing to the efficiency of the toner filling operation to be described below. Further, since the connecting member 122 has a certain degree of hardness, the user can easily attach the nozzle 102 to the pouch unit 120 as will be described below.

The nozzle 102 has a discharge passage 102g serving as a toner discharge passage for allowing the accommodating space in the pouch 101 to communicate with a space outside the toner pack 100. The nozzle 102 is engaged with the connecting member 122 such that an opening on one end side of the discharge passage 102g communicates with the accommodating space in the pouch 101. The nozzle 102 is an example of a discharge passage forming member that forms a discharge passage for discharging the toner from the accommodating portion 101a of the pouch 101. The nozzle 102 is engaged with the connecting member 122. The nozzle 102 and the connecting member 122 are separate members, but can be engaged (connected) with each other by a user. The configuration for engagement between the nozzle 102 and the connecting member 122 will be described below.

The nozzle 102 has a side surface 102c serving as an outer surface and a first outer surface extending along the rotation axis A. A discharge port 102a and a recess 102e (FIGS. 11A and 11B) are provided in the side surface 102c. In the nozzle 102, the discharge passage 102g is formed such that the internal space of the pouch 101 communicates with the discharge port 102a. The recess 102e is provided at a different position from the discharge port 102a in the rotation direction of the pack-side shutter 103. The toner contained in the pouch 101 is discharged to the outside of the toner pack 100 via the discharge passage 102g and the discharge port 102a when the pouch 101 is crushed by the user to reduce the volume of the pouch 101.

The pack-side shutter 103 serving as a shutter is disposed outside the side surface 102c of the nozzle 102. The pack-side shutter 103 is provided to be rotatable about the rotation axis A extending in a direction following the axial direction D1, and has an opening 103a. Specifically, an inner peripheral surface 103m of the pack-side shutter 103 is slidably supported with respect to an annular rib 102r of the nozzle 102. The pack-side shutter 103 is provided outside the side surface 102c in the radial direction r of the virtual circle VC with the rotation axis A as the center. An arcuate surface of the side surface 102c is a curved surface protruding outward in the radial direction r. An inner surface of the pack-side shutter 103, that is, a surface facing the side surface 102c, is a curved surface following the side surface 102c of the nozzle 102, and a pack-side seal 105 having a substantially rectangular shape is attached thereto.

The pack-side shutter 103 is configured to be rotatable about the rotation axis A between a shielding position (a position illustrated in FIG. 9A) where the pack-side seal 105 shields the discharge port 102a of the nozzle 102 and an opening position (a position illustrated in FIG. 9B) where the pack-side seal 105 opens the discharge port 102a. When the pack-side shutter 103 is located at the opening position, the discharge port 102a of the nozzle 102 is exposed from the opening 103a formed in the pack-side shutter 103.

When the pack-side shutter 103 located at the shielding position as illustrated in FIG. 9A is rotated in the direction indicated by arrow K about the rotation axis A, the pack-side shutter 103 reaches the opening position as illustrated in FIG. 9B. Conversely, when the pack-side shutter 103 located at the opening position is rotated in the direction indicated by arrow L, the pack-side shutter 103 reaches the shielding position. That is, the direction indicated by arrow K as a first rotation direction is a direction from the shielding position to the opening position around the rotation axis A, and the direction indicated by arrow L as a second rotation direction is a direction from the opening position to the shielding position around the rotation axis A. In the rotation operation of the pack-side shutter 103, the pack-side shutter 103 slides against the side surface 102c of the nozzle 102 via the pack-side seal 105.

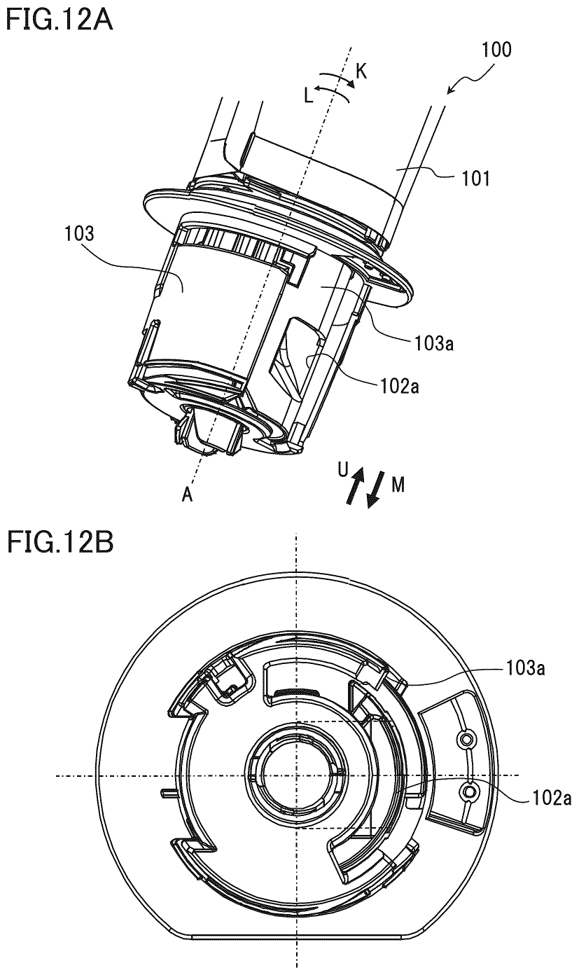

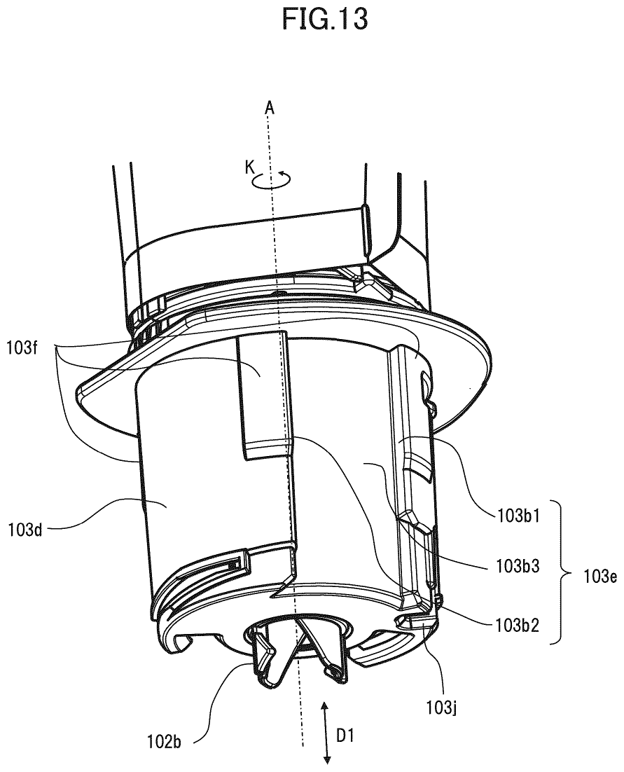

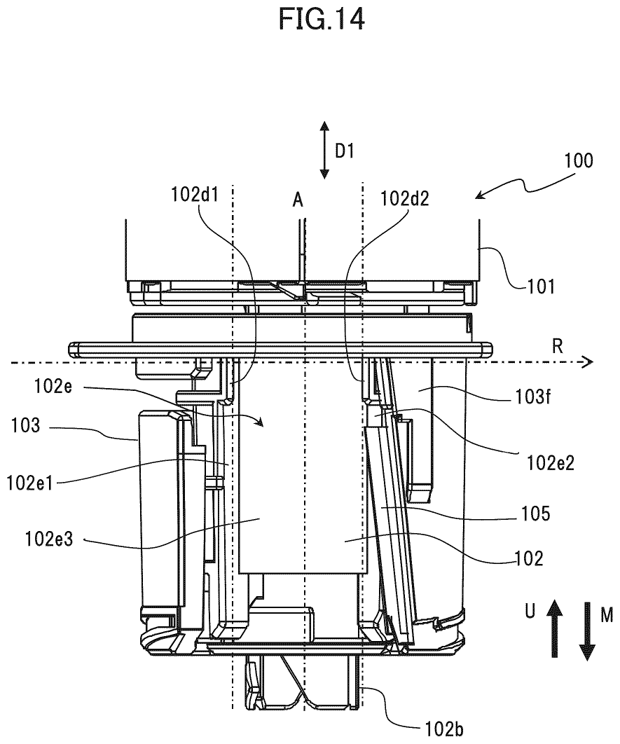

Next, detailed configurations of the nozzle 102 and the pack-side shutter 103 will be described with reference to FIGS. 11A to 14. FIG. 11A is an enlarged perspective view illustrating the vicinity of the nozzle 102 when the pack-side shutter 103 is located at the shielding position. FIG. 11B is a view of the toner pack 100 as viewed in a detaching direction U in FIG. 11A. FIG. 12A is an enlarged perspective view illustrating the vicinity of the nozzle 102 when the pack-side shutter 103 is located at the opening position. FIG. 12B is a view of the toner pack 100 as viewed in the detaching direction U in FIG. 12A. FIG. 13 is an enlarged perspective view illustrating the vicinity of the nozzle 102. FIG. 14 is a side view illustrating the nozzle 102 and the pack-side shutter 103. The detaching direction U is a direction opposite to the attaching direction M, and is a direction in which the toner pack 100 moves when being detached from the attaching part 106.

As illustrated in FIGS. 11A and 11B, the nozzle 102 includes a positioned portion 102d having a surface 102d1 and a surface 102d2 arranged in a direction indicated by arrow R with a gap therebetween and extending in a direction intersecting the direction indicated by arrow R. As illustrated in FIG. 11B, the surface 102d1 and the surface 102d2 in the present example extend in a direction perpendicular to the direction indicated by arrow R in parallel to each other. That is, in the present example, the direction indicated by arrow R is a normal direction of the surface 102d1 and the surface 102d2. The positioned portion 102d is engaged with the positioning portion 107a (FIG. 4A) of the first frame body 107 when the toner pack 100 is attached to the attaching part 106. As a result, the position of the nozzle 102 in the direction indicated by arrow R (the position in the rotation direction about the rotation axis A) with respect to the first frame body 107 (the main body base part 2) is determined. In FIG. 11B, a straight line CLI passing through the centers of the surface 102d1 and the surface 102d2 in the direction indicated by arrow R and extending in a direction perpendicular to the direction indicated by arrow R is in a phase rotated by about 90° with respect to a straight line CL2 passing through the rotation axis A and the center of the discharge port 102a.

As illustrated in FIGS. 11A and 14, a surface 102e1 and a surface 102e2 are provided in the direction of the rotation axis A downstream of the surface 102d1 and the surface 102d2, respectively, in the attaching direction M. As illustrated in FIG. 11B, the surface 102e1 and the surface 102e2 extend in the radial direction r of the virtual circle VC with the rotation axis A as the center. However, the direction in which the surface 102e1 and the surface 102e2 extend is not limited to that in the present example, and can be set to a direction that does not interfere with the positioning portion 107a of the first frame body 107.

As illustrated in FIG. 14, a side surface 102e3 is provided between the surface 102d1 and the surface 102d2 and between the surface 102e1 and the surface 102e2 in the direction indicated by arrow R. The side surface 102e3 is recessed inward in the radial direction r with respect to the side surface 102c. The surface 102d1, the surface 102d2, the surface 102e1, the surface 102e2, and the side surface 102e3 form the recess 102e.

The surface 102d1 and the surface 102d2 are not necessarily parallel to each other as in the present example. For example, the surface 102d1 and the surface 102d2 may be surfaces extending in the radial direction r of the virtual circle VC with the rotation axis A as the center. In this case, the direction indicated by arrow R is a tangential direction of the virtual circle VC, and the straight line CL1 perpendicular to the direction indicated by arrow R can be set at any angle with respect to the straight line CL2.

As illustrated in FIGS. 11A and 11B, when viewed in a direction orthogonal to the axial direction D1 of the rotation axis A, the opening 103a is provided in a side surface 103d of the pack-side shutter 103. As illustrated in FIG. 11A, when the pack-side shutter 103 is located at the shielding position, at least a part of the recess 102e of the nozzle 102 is exposed from the opening 103a. This is because, when the toner pack 100 is attached to the attaching part 106 in a state where the pack-side shutter 103 is located at the shielding position, the surface 102d1 and the surface 102d2 of the recess 102e, that is, the positioned portion 102d, is engaged with the positioning portion 107a.

Further, as illustrated in FIG. 11B, a driven transmission portion 103e is provided in the pack-side shutter 103 on the side opposite to the opening 103a with the rotation axis A being interposed therebetween. When the pack-side shutter 103 is located at the shielding position, the driven transmission portion 103e is provided on the side opposite to the recess 102e of the nozzle 102 with the rotation axis A being interposed therebetween. The driven transmission portion 103e has surfaces 103b1 and 103b2 and a side surface 103b3, and can be engaged with the driving transmission portion 108a of the operation lever 108 to be described below. Both the surface 103b1 and the surface 103b2 extend in a direction perpendicular to the direction indicated by arrow R. FIG. 13 is an enlarged perspective view of the vicinity of the pack-side shutter 103 as viewed from the side where the driven transmission portion 103e is located. The side surface 103b3 recessed inward in the radial direction r with respect to the side surface 103d is provided between the surfaces 103b1 and 103b2.

A protruding portion 102b of the nozzle 102 will be described with reference to FIGS. 11A to 14. As illustrated in FIGS. 9A and 9B, the toner pack 100 is oriented in a posture in which a second end side (a nozzle 102 side) of the toner pack 100 is below a first end side (a pouch 101 side) of the toner pack 100. Alternatively, the toner pack 100 is oriented such that at least a part of the nozzle 102 is below the pouch 101, and the rotation axis A is parallel to the vertical direction. This posture is a posture when the toner pack 100 is attached to the attaching part 106 of the image forming apparatus 1. At this time, in FIGS. 11A and 12A, the attaching direction M is a downward direction, and the detaching direction U is an upward direction.

The pack-side shutter 103 has an end surface 103c as a shutter end surface that is a lower end surface in the vertical direction VD and constitutes a bottom surface of the pack-side shutter 103. The nozzle 102 has a protruding portion 102b as a first protruding portion that protrudes downstream, that is, downward, in the attaching direction M beyond the end surface 103c of the pack-side shutter 103. As illustrated in FIG. 11A, the protruding portion 102b is a cylindrical portion (a portion having a cylindrical shape) with the rotation axis A as the center. The protruding portion 102b has a protruding portion end surface 102b2 that is a lower end surface. The protruding portion end surface 102b2 is provided with a hole having an inner peripheral surface 102b1 with the rotation axis A as the center. As illustrated in FIG. 10, the protruding portion 102b protrudes downward beyond a lower end surface 102j of the nozzle 102. In the present example, the end surface 103c of the pack-side shutter 103 and the end surface 102j of the nozzle 102 are end surfaces perpendicular to the rotation axis A, but are not limited thereto. It is only required that these surfaces extend in a direction intersecting the rotation axis A when viewed from a direction perpendicular to the rotation axis A. The protruding portion 102b is not necessarily provided in the nozzle 102.

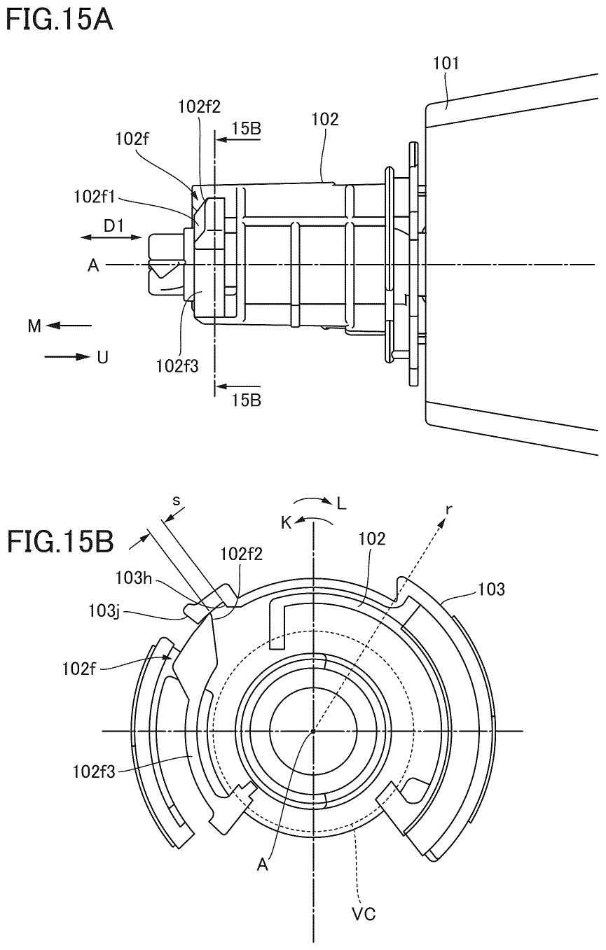

Here, as illustrated in FIG. 15A, the nozzle 102 of the toner pack 100 has a claw portion 102f serving as a lock mechanism so that the pack-side shutter 103 does not rotate with respect to the nozzle 102 at the time of transportation or when the user handles the toner pack 100 alone. The pack-side shutter 103 is held at the shielding position by the claw portion 102f, thereby making it possible to prevent the toner, which is contained in the toner pack 100, from spilling out.

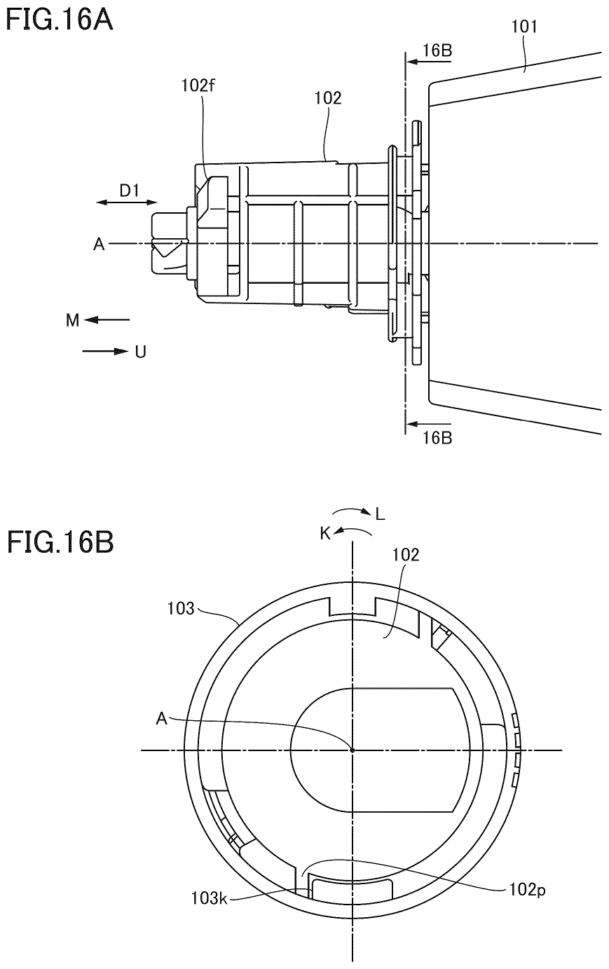

FIG. 15A is a front view illustrating the claw portion 102f. FIG. 15B is a cross-sectional view illustrating a cross section taken along line 15B-15B in FIG. 15A. FIG. 16A is a front view illustrating the claw portion 102f. FIG. 16B is a cross-sectional view illustrating a cross section taken along line 16B-16B in FIG. 16A.

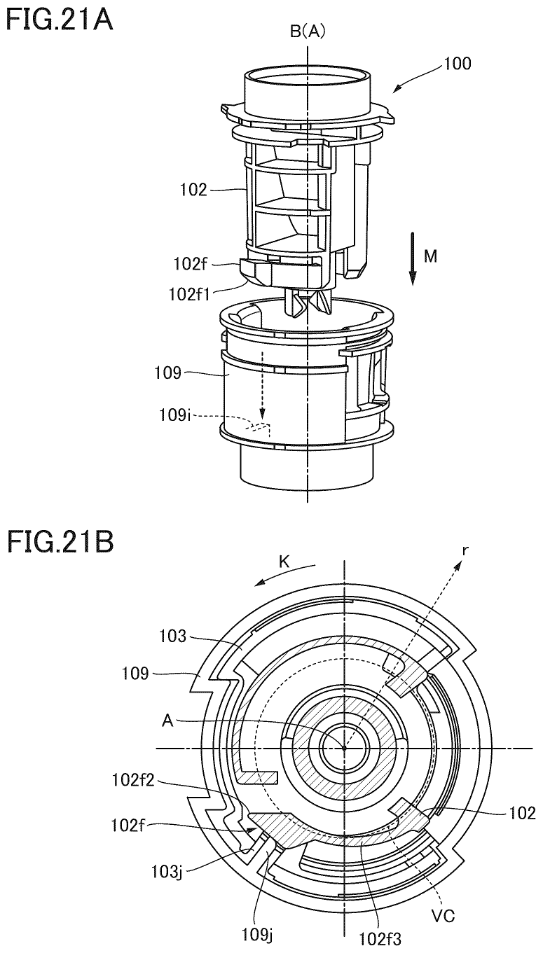

As illustrated in FIGS. 15A and 15B, the claw portion 102f serving as a second restricting portion includes an arm portion 102f3, a release slope 102f1, and an abutment portion 102f2. The claw portion 102f is movable in the radial direction r of the virtual circle VC with the rotation axis A as the center by elastically deforming the arm portion 102f3. Specifically, the claw portion 102f is movable between a restricting position illustrated in FIG. 15B and a non-restricting position illustrated in FIG. 21B, which is a position inside the restricting position in the radial direction r.

When the claw portion 102f is located at the restricting position as illustrated in FIG. 15B, the abutment portion 102f2 faces a restricting portion 103h of the pack-side shutter 103 located at the shielding position in the circumferential direction with the rotation axis A as the center. At this time, a space s is provided between the abutment portion 102f2 and the restricting portion 103h. When the restricting portion 103h abuts against the abutment portion 102f2, the pack-side shutter 103 is restricted from rotating in the direction indicated by arrow K. The size of the space s may be arbitrarily set, and the rotation range in which the pack-side shutter 103 can rotate within the space s is regarded as the shielding position. That is, the pack-side shutter 103 is restricted from rotating in the direction indicated by arrow K from the shielding position by the claw portion 102f located at the restricting position.

When the claw portion 102f is located at the non-restricting position, the abutment portion 102f2 is located inside the restricting portion 103h of the pack-side shutter 103 in the radial direction r of the virtual circle VC with the rotation axis A as the center. Therefore, the pack-side shutter 103 can rotate about the rotation axis A without interfering with the abutment portion 102f2.

As illustrated in FIGS. 6A and 21B, the apparatus-side shutter 109 has a restriction release rib 109j extending in the axial direction D1. The restriction release rib 109j can abut on the release slope 102f1 of the claw portion 102f when the toner pack 100 is attached to the attaching part 106. As illustrated in FIGS. 11B, 15B, 17B, and 21B, the pack-side shutter 103 has an opening portion 103j, and the opening portion 103j extends from the end surface (the bottom surface) 103c to the side surface 103d of the pack-side shutter 103. The restriction release rib 109j provided in the apparatus-side shutter 109 can penetrate the opening portion 103j and abut on the release slope 102f1 of the claw portion 102f disposed inside the pack-side shutter 103.

The release slope 102f1 is inclined with respect to the attaching direction M (the axial direction D1) so as to extend inward in the radial direction r and downstream in the attaching direction M. When the toner pack 100 is attached to the attaching part 106, the release slope 102f1 converts the direction of the force that the claw portion 102f receives from the restriction release rib 109j inward in the radial direction r. As a result, the release slope 102f1 is pressed by the restriction release rib 109j, so that the claw portion 102f moves inward in the radial direction r from the restricting position toward the non-restricting position. In other words, when the toner pack 100 is attached to the attaching part 106, the claw portion 102f is pressed by the attaching part 106, and moves from the restricting position to the non-restricting position.

The abutment portion 102f2 of the claw portion 102f described above abuts against the restricting portion 103h of the pack-side shutter 103, thereby restricting the rotation of the pack-side shutter 103 in the direction indicated by arrow K. Next, the configuration for restricting the rotation of the pack-side shutter 103 in the direction indicated by arrow L opposite to the direction indicated by arrow K will be described.

As illustrated in FIG. 16B, the pack-side shutter 103 includes a rotation restricting rib 103k, and the nozzle 102 includes a rotation restricting surface 102p as a first restricting portion facing the rotation restricting rib 103k in the circumferential direction with the rotation axis A as the center. When the pack-side shutter 103 is located at the shielding position, the rotation restricting rib 103k faces the rotation restricting surface 102p with a slight space therebetween. Then, when the pack-side shutter 103 located at the shielding position tries to rotate in the direction indicated by arrow L, the rotation restricting rib 103k abuts against the rotation restricting surface 102p, and the rotation of the pack-side shutter 103 in the direction indicated by arrow L is restricted.

As illustrated in FIGS. 16A and 16B, the claw portion 102f is disposed downstream of the rotation restricting surface 102p and the rotation restricting rib 103k in the attaching direction M. This is because the claw portion 102f is disposed at a position where it can be easily pressed by the restriction release rib 109j of the apparatus-side shutter 109 when the toner pack 100 is attached to the attaching part 106. As a result, the size of the opening portion 103j provided in the pack-side shutter 103 can be reduced, while ensuring the stiffness of the pack-side shutter 103, and the access to the claw portion 102f by the user can be suppressed. The arrangement of the claw portion 102f, the rotation restricting surface 102p, and the rotation restricting rib 103k is not limited thereto, and may be arbitrarily changed.

As described above, in a state where the toner pack 100 is not attached to the attaching part 106, the pack-side shutter 103 is restricted from rotating in the direction indicated by arrow K and in the direction indicated by arrow L, and is easily held at the shielding position. When the pack-side shutter 103 is rotated in the direction indicated by arrow K in a state where the toner pack 100 is attached to the attaching part 106 and the claw portion 102f is located at the non-restricting position, the discharge port 102a of the nozzle 102 is exposed as illustrated in FIG. 12A.

As illustrated in FIGS. 11A and 13, the pack-side shutter 103 is provided with three radial positioning portions 103f. These radial positioning portions 103f protrude outward in the radial direction r from the side surface 103d. Each of the radial positioning portions 103f is disposed on the upstream side of the pack-side shutter 103 in the attaching direction M.

### Attaching Toner Pack on Attaching Part

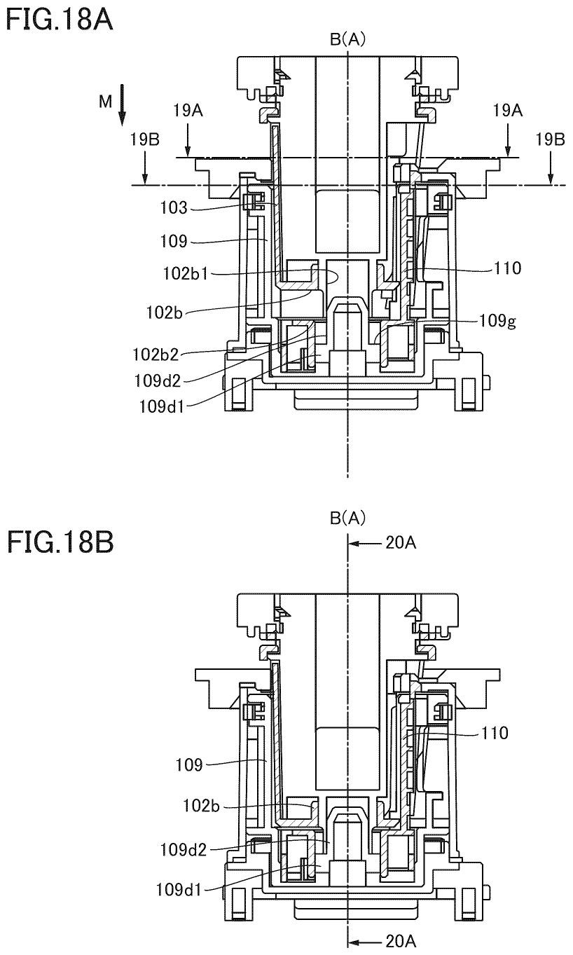

Next, a state when the toner pack 100 is attached to the attaching part 106 will be described with reference to FIGS. 17A to 21B. FIGS. 17A and 17B are perspective views of the toner pack 100 in a state where it is being attached to the attaching part 106 as viewed from different angles. FIG. 18A is a cross-sectional view illustrating the toner pack 100 in a state where it is being attached toward the attaching part 106. FIG. 18B is a cross-sectional view illustrating the toner pack 100 in a state where it has been attached to the attaching part 106.

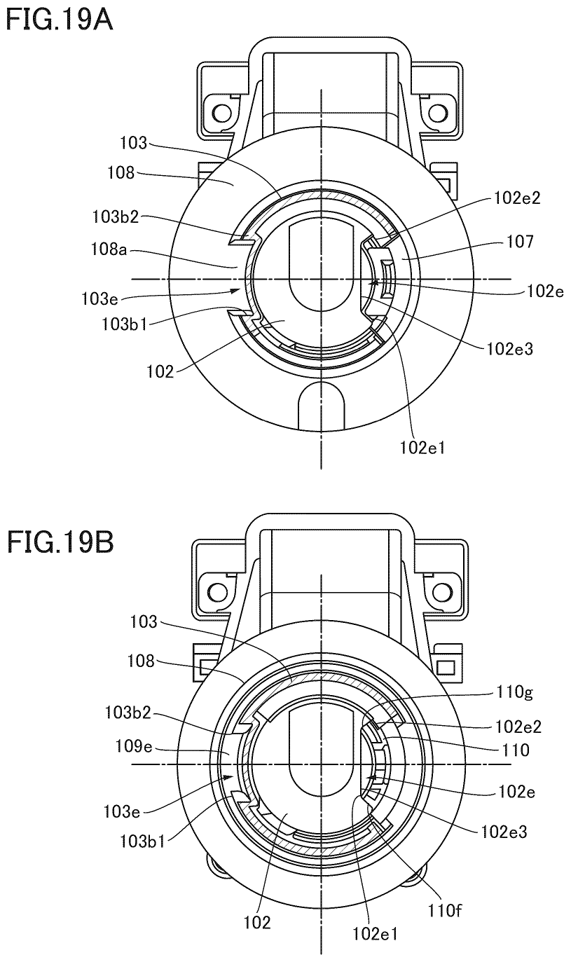

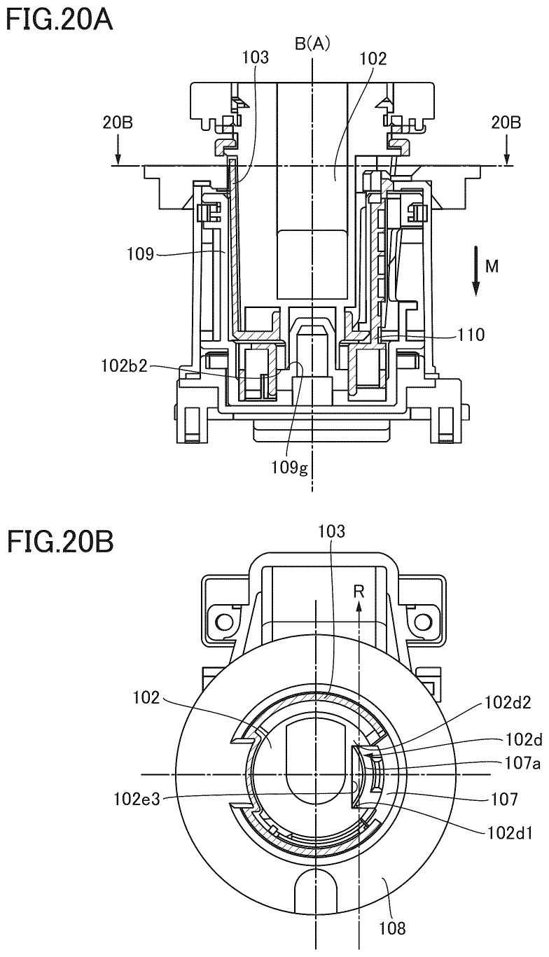

FIG. 19A is a cross-sectional view illustrating a cross section taking along line 19A-19A in FIG. 18A. FIG. 19B is a cross-sectional view illustrating a cross section taken along line 19B-19B in FIG. 18A. FIG. 20A is a cross-sectional view illustrating a cross section taken along line 20A-20A in FIG. 18B. FIG. 20B is a cross-sectional view illustrating a cross section taken along line 20B-20B in FIG. 20A. FIG. 21A is a perspective view illustrating the toner pack 100 in a state where it is being attached to the apparatus-side shutter 109. In FIG. 21A, the pouch 101, the connecting member 122, and the pack-side shutter 103 of the toner pack 100 are omitted, and only the nozzle 102 is illustrated. FIG. 21B is a cross-sectional view illustrating a cross section taken along line 16B-16B in FIG. 16A in a state where the toner pack 100 has been attached to the attaching part 106. Note that, for the sake of visibility, the cut surfaces of the pack-side shutter 103 and the cover 110 are hatched in FIGS. 18A to 20B, and the cut surface of the nozzle 102 is hatched in FIG. 21B.

Then, as illustrated in FIGS. 17A and 17B, the user moves the toner pack 100 in a state where the pack-side shutter 103 is located at the shielding position in the attaching direction M with respect to the attaching part 106 in a state where the apparatus-side shutter 109 is located at the shielding position to attach the toner pack 100 to the attaching part 106. At this time, the user aligns the recess 102e of the nozzle 102 and the opening 103a of the pack-side shutter 103 with the positioning portion 107a of the first frame body 107. At the same time, the user aligns the driven transmission portion 103e of the pack-side shutter 103 and the driving transmission portion 108a of the operation lever 108.

After such alignment between the toner pack 100 and the attaching part 106, the user moves the toner pack 100 in the attaching direction M to attach the toner pack 100 to the attaching part 106. Then, as illustrated in FIG. 18A, a small-diameter portion 109d2 of the center boss 109d of the apparatus-side shutter 109 is fitted to the inner peripheral surface 102b1 of the protruding portion 102b of the nozzle 102. As a result, the position of the nozzle 102 in the radial direction r with respect to the apparatus-side shutter 109 is determined.

At this time, as illustrated in FIG. 19A, the driving transmission portion 108a of the operation lever 108 and the driven transmission portion 103e of the pack-side shutter 103 are engaged with each other. At the same time, as illustrated in FIG. 19B, a side surface 110f and a side surface 110g of the cover 110 approach or are engaged with the surface 102e1 and the surface 102e2 forming the recess 102e of the nozzle 102. As illustrated in FIGS. 19A and 19B, the driven transmission portion 103e of the pack-side shutter 103 is engaged with the driven transmission portion 109e of the apparatus-side shutter 109 and the driving transmission portion 108a of the operation lever 108. As a result, the rotation axis A of the pack-side shutter 103 and the rotation axis B of the apparatus-side shutter 109 are substantially coaxial.

In addition, since the surfaces 102e1 and 102e2 of the recess 102e of the nozzle 102 are engaged with the side surfaces 110f and 110g of the cover 110, respectively, the nozzle 102 of the toner pack 100 does not rotate with respect to the main body base part 2 including the cover 110. In other words, when the toner pack 100 is attached to the image forming apparatus 1, the recess 102e is engaged with the cover 110 of the image forming apparatus 1 to restrict the rotation of the nozzle 102 with respect to the image forming apparatus 1. Then, the operation lever 108, the pack-side shutter 103, and the apparatus-side shutter 109 are rotatable about the rotation axis B substantially integrally with the main body base part 2 and the nozzle 102.

Specifically, when the operation lever 108 is rotated, the driving transmission portion 108a of the operation lever 108 presses the surface 103b1 or 103b2 of the pack-side shutter 103, and the pack-side shutter 103 is rotated. Thereafter, the surface 103b1 or the surface 103b2 constituting the driven transmission portion 103e of the pack-side shutter 103 presses the driven transmission portion 109e of the apparatus-side shutter 109, and the apparatus-side shutter 109 is rotated.

In a state where the toner pack 100 has been attached to the attaching part 106, the three radial positioning portions 103f (see FIGS. 11A and 13) of the pack-side shutter 103 come into contact with the inner peripheral surface 109h (see FIG. 6A) of the apparatus-side shutter 109. As a result, the position of the toner pack 100 in the radial direction r on the upstream side in the attaching direction M is determined.

As illustrated in FIG. 20A, the protruding portion end surface 102b2 of the protruding portion 102b of the nozzle 102 abuts against the pack abutment surface 109g of the apparatus-side shutter 109, whereby the position of the toner pack 100 in the attaching direction M is determined. The protruding portion 102b of the nozzle 102 may be positioned in such a manner that the outer peripheral surface of the protruding portion 102b is fitted to the cylindrical portion 110j (see FIGS. 6A and 6B) of the cover 110.

As illustrated in FIG. 20B, the positioned portion 102d provided in the nozzle 102 is engaged with the positioning portion 107a of the first frame body 107. Accordingly, the nozzle 102 of the toner pack 100 is restricted from rotating with respect to the first frame body 107 (the main body base part 2).

As illustrated in FIGS. 21A and 21B, when the toner pack 100 is attached to the attaching part 106, the claw portion 102f provided in the nozzle 102 moves from the restricting position to the non-restricting position (the position illustrated in FIG. 21B) as described above. More specifically, the release slope 102f1 is pressed by the restriction release rib 109j, so that the claw portion 102f moves inward in the radial direction r from the restricting position toward the non-restricting position. As a result, the restriction on the rotation of the pack-side shutter 103 in the direction indicated by arrow K is released.

### Operation of Operation Lever

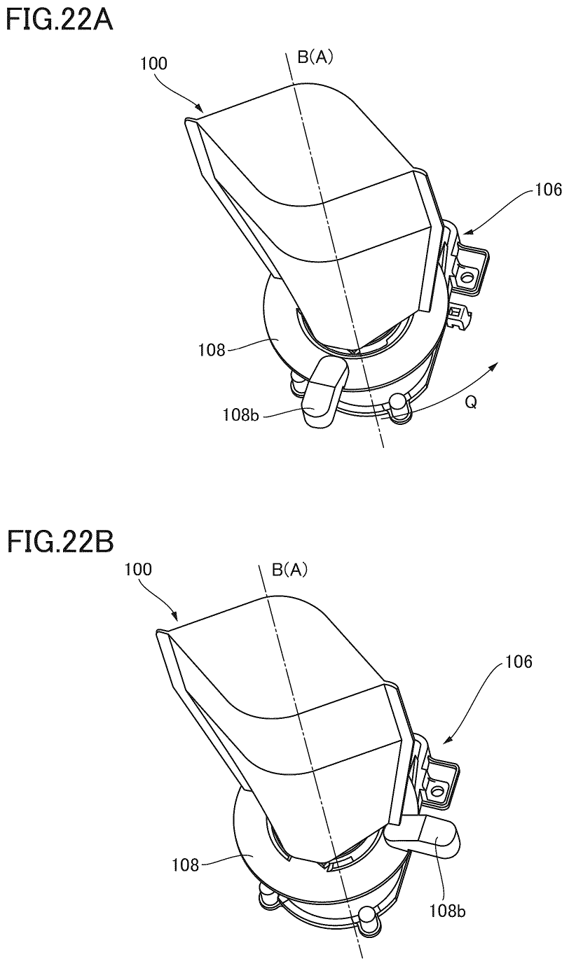

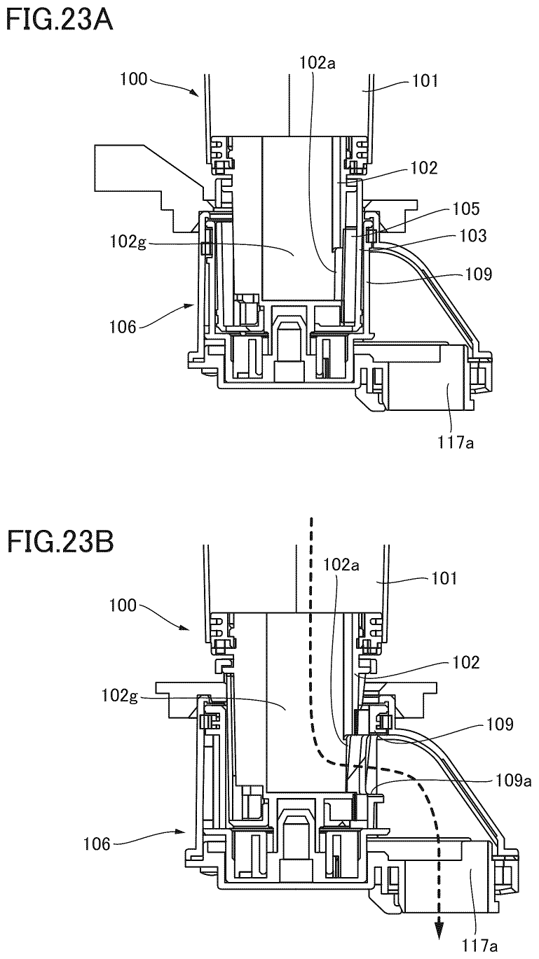

FIG. 22A is a perspective view illustrating the operation lever 108 and the toner pack 100 located at the closed position. FIG. 22B is a perspective view illustrating the operation lever 108 and the toner pack 100 located at the opened position. FIG. 23A is a cross-sectional view illustrating the toner pack 100 and the attaching part 106 when both the apparatus-side shutter 109 and the pack-side shutter 103 are located at the shielding position. FIG. 23B is a cross-sectional view illustrating the toner pack 100 and the attaching part 106 when both the apparatus-side shutter 109 and the pack-side shutter 103 are located at the opening position.

As described above, in a state where the toner pack 100 is attached to the attaching part 106, the operation lever 108, the pack-side shutter 103, and the apparatus-side shutter 109 are rotatable about the rotation axis B integrally with the main body base part 2 and the nozzle 102. In a state where the toner pack 100 is attached to the attaching part 106 and the operation lever 108 is located at the closed position, the discharge port 102a is shielded by the pack-side shutter 103, the pack-side seal 105, and the apparatus-side shutter 109 as illustrated in FIG. 23A. Therefore, the toner in the pouch 101 cannot reach the apparatus-side opening 117a of the second frame body 117.

As illustrated in FIGS. 22A and 22B, when the operation lever 108 is rotated in a direction indicated by arrow Q from the closed position to the opened position in a state where the toner pack 100 is attached to the attaching part 106, the pack-side shutter 103 and the apparatus-side shutter 109 rotate from the shielding position to the opening position.

More specifically, the driving transmission portion 108a of the operation lever 108 presses the surface 103b1 of the pack-side shutter 103. As a result, the pack-side shutter 103 is rotated together with the operation lever 108 from the shielding position to the opening position. In other words, when the driving transmission portion 108a and the surface 103b1 are engaged with each other, the pack-side shutter 103 rotates from the shielding position to the opening position in conjunction with the rotation of the operation lever 108. In addition, the surface 103b2 of the pack-side shutter 103 rotated from the shielding position to the opening position presses the driven transmission portion 109e of the apparatus-side shutter 109. As a result, the apparatus-side shutter 109 is rotated together with the pack-side shutter 103 from the shielding position to the opening position. In other words, when the surface 103b2 and the driven transmission portion 109e are engaged with each other, the apparatus-side shutter 109 rotates integrally with the pack-side shutter 103 in conjunction with the rotation of the operation lever 108.

Then, as illustrated in FIG. 23B, the pack-side shutter 103, the pack-side seal 105, and the apparatus-side shutter 109 move, whereby the discharge port 102a of the nozzle 102 is opened. That is, the pouch 101 of the toner pack 100 and the storage 36 (FIG. 1A) of the developing container 32 communicate with each other via the discharge passage 102g, the discharge port 102a, the receiving port 109a, and the apparatus-side opening 117a. When the user compresses the pouch 101, the toner in the pouch 101 is supplied together with air to the storage 36 of the developing container 32 through the discharge port 102a, the receiving port 109a, and the apparatus-side opening 117a.

When the supply of the toner from the toner pack 100 to the developing container 32 is completed, the user rotates the operation lever 108 from the opened position to the closed position. When the operation lever 108 is rotated from the opened position to the closed position, the driving transmission portion 108a of the operation lever 108 presses the surface 103b2 of the pack-side shutter 103. As a result, the pack-side shutter 103 is rotated together with the operation lever 108 from the opening position to the shielding position. In addition, the surface 103b1 of the pack-side shutter 103 rotated from the opening position to the shielding position presses the driven transmission portion 109e of the apparatus-side shutter 109. As a result, the apparatus-side shutter 109 is rotated together with the pack-side shutter 103 from the opening position to the shielding position.

In this state, the user pulls out the toner pack 100 from the attaching part 106, whereby the toner supply operation is completed.

### Details of Toner Pack

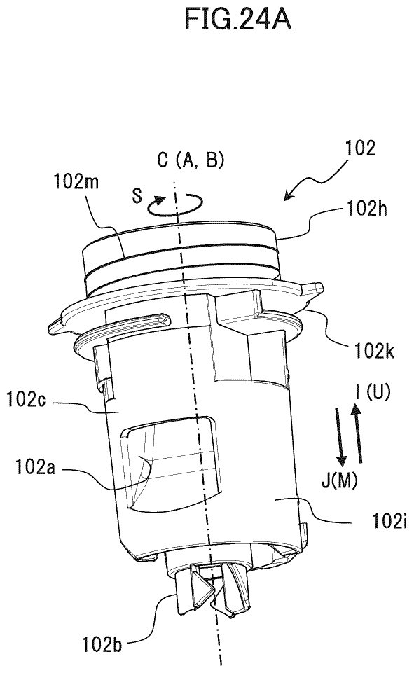

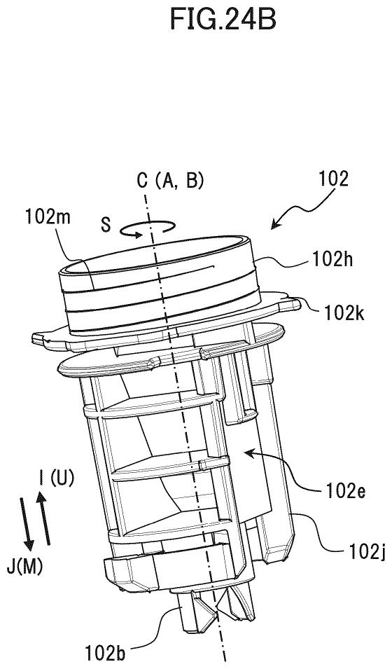

A method for manufacturing the toner pack 100 and a configuration for connecting the nozzle 102 and the connecting member 122 according to the present example will be described in detail with reference to FIGS. 24A to 28B.

### Process of Manufacturing Toner Pack

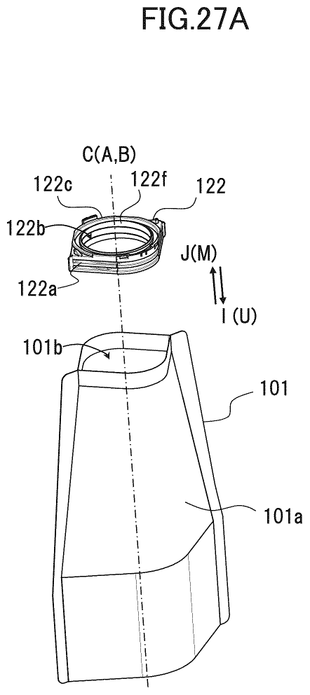

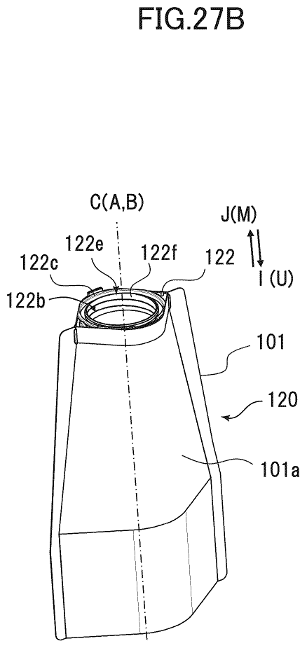

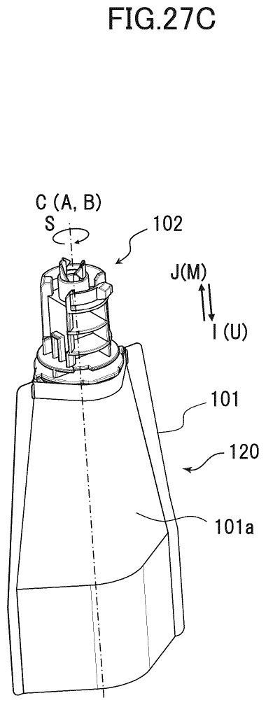

First, a process of manufacturing the toner pack according to the present example will be described with reference to FIGS. 27A to 27C. FIG. 27A is a perspective view illustrating a separated state before the connecting member 122 is connected to the pouch 101. FIG. 27B is a perspective view illustrating a state after the connecting member 122 is connected to the pouch 101. FIG. 27C is a perspective view illustrating a state after the connecting member 122 is connected to the pouch 101 and then the nozzle 102 is connected to the pouch 101.

As described above, the toner pack 100 according to the present example includes a pouch 101 serving as a containing member (accommodating member) that accommodates toner, a connecting member 122 connected to the pouch 101, a nozzle 102 connected to the connecting member 122, and a pack-side shutter 103. In the manufacture of the toner pack 100, the above-mentioned members are assembled, and the toner is filled in the pouch 101.

Specifically, as illustrated in FIGS. 27A and 27B, first, the connecting member 122 is attached to the pouch 101 (first assembling step). As a result, a pouch unit 120 in which the pouch 101 and the connecting member 122 are integrated is created. The method of connecting (joining) the connecting member 122 and the pouch 101 is not limited to a specific method as described above, and for example, adhesion or thermal welding can be used.

Next, as illustrated in FIG. 27B, with respect to the pouch unit 120 in a state where the nozzle unit 130 is not attached (toner filling mode), toner is filled in the pouch 101 through the opening portion of the connecting member 122 (filling step). Then, as illustrated in FIG. 27C, the nozzle 102 is engaged with the connecting member 122 to create a pouch/nozzle assembly including the nozzle 102 and the pouch unit 120 (second assembling step). The configuration for engagement between the nozzle 102 and the connecting member 122 will be described in detail below. Lastly, the pack-side shutter 103 is attached to the nozzle 102, thereby completing the toner pack 100 illustrated in FIGS. 9A, 9B, 10, or the like (third assembling step).

Note that the procedure of completing the assembly of the nozzle unit 130 by attaching the pack-side shutter 103 to the nozzle 102 after attaching the nozzle 102 to the pouch unit 120 has been described here. Alternatively, the nozzle unit 130 in which the pack-side shutter 103 is attached to the nozzle 102 in advance may be prepared, and the nozzle 102 may be engaged with the connecting member 122, thereby attaching the nozzle unit 130 to the pouch unit 120 at a time. That is, in the present example, the nozzle 102 can be attached to and detached from the pouch unit 120 alone, and may be attached to and detached from the pouch unit 120 as a part of the nozzle unit 130.

### Filling of Toner

As described above, in the present example, the toner is filled in the pouch 101 in a state where the connecting member 122 is attached to the pouch 101 (FIG. 27B) before the nozzle 102 is attached. That is, the toner filling step is performed after the first assembling step and before the second assembling step.

For example, the toner filling step may be performed, for example, through the opening portion 101b of the pouch 101 before attaching the connecting member 122. However, the pouch 101 is a flexible member, and some measure for maintaining the shape of the opening portion 101b during toner filling is required. According to the present example, the shape of the filling port can be maintained by attaching the connecting member 122 that is a resin part, and using the opening portion of the connecting member 122 as a toner filling port. For this reason, a process of opening the opening portion 101b of the pouch 101 and maintaining it in the opened state even during the filling of the toner and a tool therefor are unnecessary.

Instead of the above-described method, for example, the toner may be filled in the pouch 101 using the discharge port 102a of the nozzle 102 in a state where the nozzle 102 is attached to the pouch 101. However, depending on the shape of the discharge port 102a, it may not be easy to fill the toner, and the filling operation may not be efficiently performed. In particular, in a configuration in which the discharge port 102a is open on the side surface of the nozzle 102, such as the nozzle 102 of the present example, in a direction intersecting the longitudinal direction of the toner pack 100, it may be difficult to efficiently perform toner filling via the discharge port 102a. In the present example, the toner is filled by using the opening portion of the connecting member 122, which has a larger opening area than the discharge port 102a and is open straight with respect to the accommodating portion 101a of the pouch 101 along the longitudinal direction of the toner pack 100. As a result, the toner can be easily filled, and the filling operation can be efficiently performed.

### Configuration for Engagement Between Nozzle and Connecting Member

Next, a configuration for engagement between the nozzle 102 and the connecting member 122 according to the present example will be described with reference to FIGS. 24A to 28B.

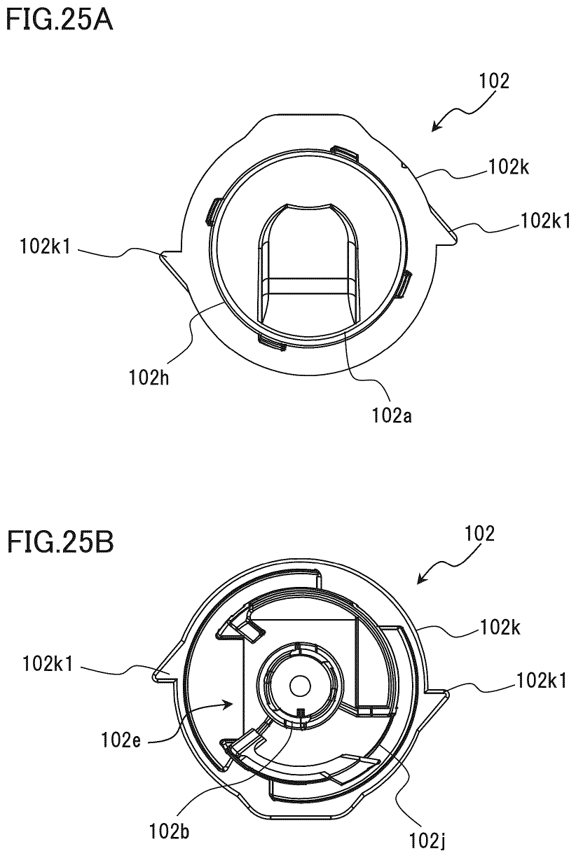

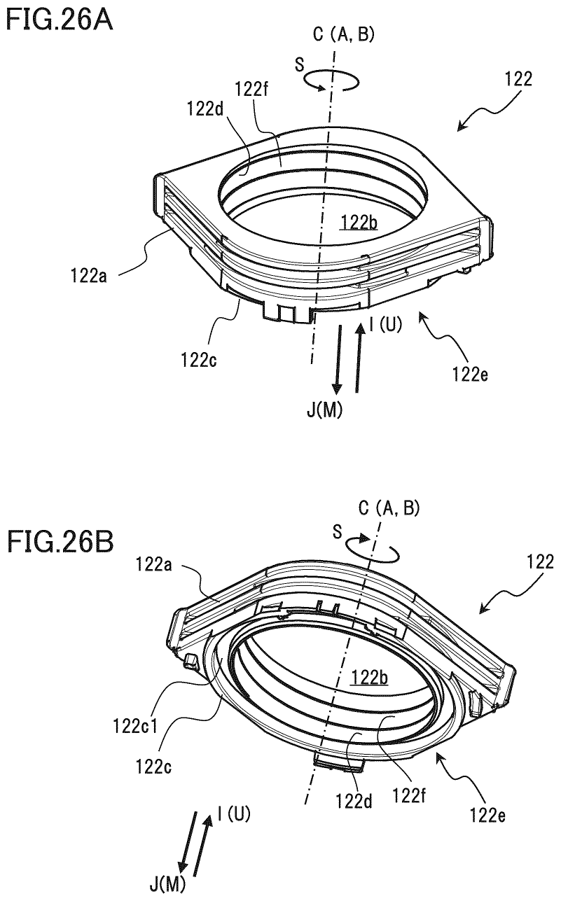

FIG. 24A is a perspective view of the nozzle 102 according to the present example. FIG. 24B is a perspective view of the nozzle 102 from a viewpoint different from that in FIG. 24A. FIG. 25A is a view of the nozzle 102 according to the present example as viewed from the pouch 101 side. FIG. 25B is a view of the nozzle 102 according to the present example as viewed from the side opposite to the pouch 101. FIG. 26A is a perspective view of the connecting member 122 according to the present example. FIG. 26B is a perspective view of the connecting member 122 according to the present example from a viewpoint different from that in FIG. 26A.

Hereinafter, the direction in which the nozzle 102 moves when the nozzle 102 is engaged with the connecting member 122 will be referred to as an insertion direction I. The direction in which the nozzle 102 moves when the nozzle 102 is detached from the connecting member 122 will be referred to as a detachment direction J. A virtual straight line following the insertion direction I and the detachment direction J and passing through the center of the through hole 122b of the connecting member 122 when viewed in the insertion direction will be referred to as an axis C. In the present example, the axis C is a rotation axis of the nozzle 102 when the nozzle 102 is rotated to engage the nozzle 102 with the connecting member 122.

In the present example, with the connecting member 122 as a reference, the insertion direction I is a direction substantially parallel to the attaching direction M of the toner pack 100 described above, and the detachment direction J is a direction substantially parallel to the detaching direction U of the toner pack 100 described above. The axis C substantially coincides with the rotation axes A and B, with the connecting member 122 as a reference.

As illustrated in FIGS. 26A, 26B, 27A, and 27B, the connecting member 122 is an annular member attached along the inner periphery of the opening portion 101b of the pouch 101. The connecting member 122 has an outer peripheral portion 122a having a shape corresponding to the opening portion 101b of the pouch 101, and a through hole 122b for allowing the accommodating portion 101a of the pouch 101 to communicate with the outside when the connecting member 122 is connected to the opening portion 101b of the pouch 101. The through hole 122b is a hole formed in a range including the axis C when viewed in the insertion direction I, and penetrating the connecting member 122 in a direction following the axis C. In order to improve the efficiency of the toner filling operation described above, the opening area of the through hole 122b when viewed in the insertion direction I is preferably larger than the opening area of the discharge port 102a (FIG. 24A) in the side surface 102c of the nozzle 102.

The connecting member 122 has a facing portion 122c facing the nozzle 102 in the insertion direction I when the nozzle 102 is connected to the connecting member 122. The facing portion 122c is a portion exposed to the outside of the pouch 101 when the pouch unit 120 (FIG. 27B) is viewed from the detachment direction J side (the upstream side in the insertion direction I) in a state where the connecting member 122 is connected to the opening portion 101b of the pouch 101.

The opening portion 101b of the pouch 101 is open toward the detachment direction J, and the through hole 122b penetrates the connecting member 122 in a direction following the axis C in a state where the connecting member 122 is connected to the opening portion 101b. The through hole 122b serves as a filling port for filling toner in the accommodating portion 101a of the pouch 101 in the toner filling step described above.

The through hole 122b is formed by an inner peripheral surface 122d of the connecting member 122 having an axis parallel to the insertion direction I and the detachment direction J as a central axis. Furthermore, a female screw portion 122f serving as an engaged portion is formed in the inner peripheral surface 122d. The inner peripheral surface 122d and the female screw portion 122f form an inserted portion 122e into which an inserting portion 102h of the nozzle 102 to be described below is inserted at the time of assembling the nozzle 102 (second assembling step).

As illustrated in FIGS. 24A, 24B, 25A, and 25B, the nozzle 102 includes an inserting portion 102h, an attached portion 102i, and a flange 102k.

The inserting portion 102h is a portion inserted into the inserted portion 122e of the connecting member 122. The inserting portion 102h has a substantially cylindrical shape with the axis C as the center, and protrudes from the flange 102k in the insertion direction I. A male screw portion 102m serving as an engaging portion is formed on the outer peripheral surface of the inserting portion 102h.

In the toner pack 100 of the present example, the male screw portion 102m provided as an engaging portion in the nozzle 102 and the female screw portion 122f provided as an engaged portion in the connecting member 122 can be engaged with and disengaged from each other. As a result, the nozzle 102 serving as a discharge passage forming member can be attached to and detached from (attachable to and detachable from) the pouch unit 120 serving as a container unit. In addition, the nozzle unit 130 serving as a discharge passage forming unit can be attached to and detached from (attachable to and detachable from) the pouch unit 120 serving as a container unit.

The male screw portion 102m and the female screw portion 122f are examples of the engaging portion and the engaged portion, and an engagement method other than the screw engagement method may be used as will be described in other examples and modifications below.

The attached portion 102i is a portion of the nozzle 102 to be attached to the attaching part 106 of the image forming apparatus 1 when the toner pack 100 is attached to the image forming apparatus 1. The attached portion 102i protrudes from the flange 102k in the detachment direction J. That is, the attached portion 102i is provided on the side opposite to the inserting portion 102h with the flange 102k interposed therebetween. The attached portion 102i is a portion exposed to the outside of the pouch/nozzle assembly (FIG. 27C) in a state where the nozzle 102 is connected to the connecting member 122 at the time of assembling the toner pack 100. The discharge port 102a, the protruding portion 102b, and the like described above are provided in the attached portion 102i.

The flange 102k is provided between the inserting portion 102h and the attached portion 102i in the insertion direction I, and spreads in a disc shape in a direction orthogonal to the insertion direction I. The flange 102k has a larger outer diameter than the male screw portion 102m. The flange 102k forms a facing surface (abutment surface) facing the facing portion 122c (FIG. 27B) of the connecting member 122 in the insertion direction I when the inserting portion 102h is inserted into the inserted portion 122e. When the nozzle 102 is engaged with the connecting member 122, the position where the facing surface of the flange 102k abuts against the facing portion 122c of the connecting member 122 is an insertion completion position (engagement position) of the inserting portion 102h with respect to the inserted portion 122e.

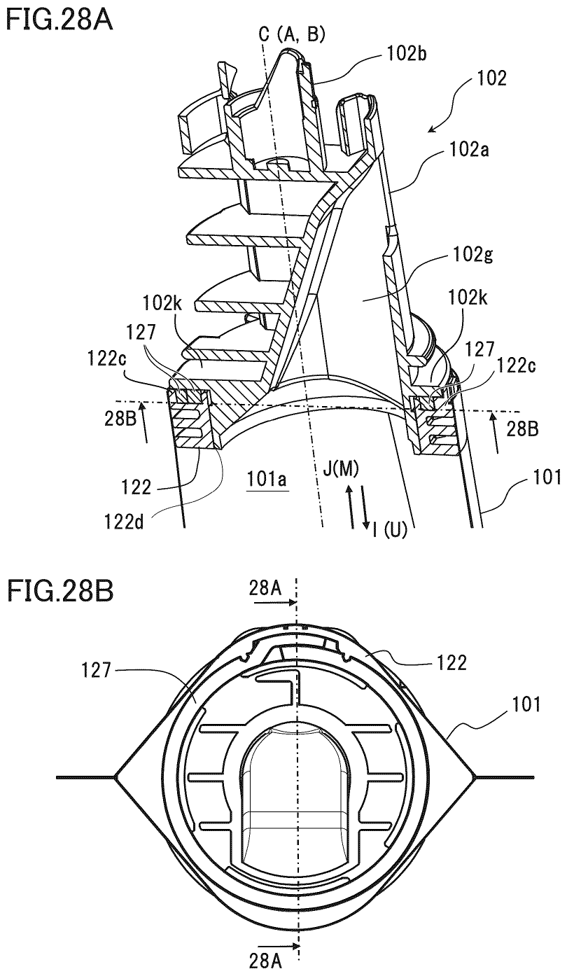

FIG. 28A is a cross-sectional view illustrating a state in which the pouch/nozzle assembly is cut along a plane including the axis C, and is a cross-sectional view taken along line 28A-28A in FIG. 28B. FIG. 28B is a cross-sectional view illustrating a configuration of a seal member 127, and is a cross-sectional view taken along line 28B-28B in FIG. 28A.

As illustrated in FIGS. 28A and 28B, the flange 102k of the nozzle 102 and the facing portion 122c of the connecting member 122 are in contact with each other via the seal member 127. The seal member 127 is a string-like or annular member disposed so as to surround the outer periphery of the through hole 122b, and is a rubber-like or sponge-like elastic member. The seal member 127 of the present example is fitted into a groove 122c1 (FIG. 26B) provided in the facing portion 122c of the connecting member 122. When the inserting portion 102h is inserted up to the insertion completion position to engage the nozzle 102 with the connecting member 122, the seal member 127 is compressed between the facing portion 122c and the flange 102k.

In this manner, by providing the seal member 127 that seals a space between the connecting member 122 and the nozzle 102, it is possible to prevent the toner from leaking from the space in the configuration in which the nozzle unit 130 is attachable to and detachable from the pouch unit 120.

### Toner Supply Method

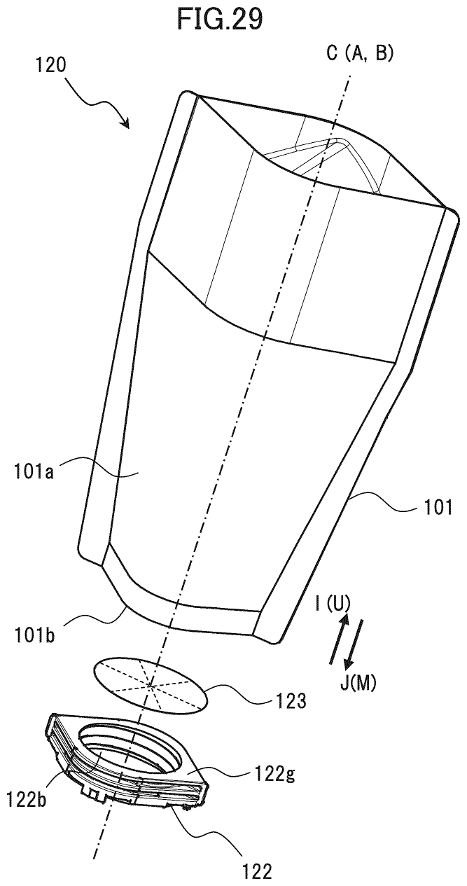

A toner supply method according to the present example will be described with reference to FIGS. 29 to 32B.

FIG. 29 is an exploded perspective view of a sealed pouch unit 120 as a pouch unit 120 serving as a container unit of a developer supply container. The sealed pouch unit 120 is a pouch unit 120 in a state in which the accommodating space inside the pouch 101 is sealed so as to prevent leakage of the toner.

As illustrated in FIG. 29, the sealed pouch unit 120 includes a pouch 101, a connecting member 122, and a developer seal 123, which is an example of a sealing member. The developer seal 123 is attached in a closely adhering state to an end surface 122g in the insertion direction I of the connecting member 122 by adhesion or another method to seal the through hole 122b.

That is, the connecting member 122 of the present example has an outer peripheral portion 122a (FIGS. 26A and 26B) serving as a first surface joined to the opening portion 101b of the pouch 101, and an end surface 122g serving as a second surface joined to the developer seal 123.

In a state where the developer seal 123 is attached, the toner contained in the accommodating portion 101a of the pouch 101 is sealed by the developer seal 123, so that the toner can be prevented from flowing out from the opening portion 101b. That is, the sealed pouch unit 120 can be handled separately from the nozzle unit 130.

When the remaining amount of the toner in the process unit 20 becomes low, the user can purchase a sealed pouch unit 120 and assemble the toner pack 100 by combining the sealed pouch unit 120 with the nozzle unit 130 owned by the user. To assemble the toner pack 100, the nozzle unit 130 detached from the used toner pack 100 may be attached to the sealed pouch unit 120. Then, the user attaches the assembled toner pack 100 to the attaching part 106 of the image forming apparatus 1 to supply toner to the developing container 32 serving as a developer storage inside the image forming apparatus.

In this manner, the nozzle unit 130 can be detached from the used toner pack 100 and attached to a new pouch unit 120, so that the nozzle unit 130 can be reused.

Although the case where the user owns the used toner pack 100 has been described here, the nozzle unit 130 may be sold alone assuming that the nozzle unit 130 cannot be reused due to damage or the like or the user does not have the nozzle unit 130 on hand. Whether to purchase a new toner pack 100 with a nozzle unit 130 attached to a pouch unit 120 or to purchase a sealed pouch unit 120 may be selected by the user. In addition, a sealed pouch unit 120 and a nozzle unit 130 may be sold together.

The set of the sealed pouch unit 120 and the nozzle unit 130 is an example of a developer supply container set that can be used as a developer supply container by attaching the nozzle unit 130 serving as a discharge passage forming unit to the pouch unit 120 serving as a container unit. The sealed pouch unit 120 is an example of a container unit that can be used as a developer supply container when the nozzle unit 130 serving as a discharge passage forming unit is attached.

The nozzle unit 130 can also be sold together with the image forming apparatus 1. In addition, an accommodating space for accommodating the nozzle unit 130 may be provided in the image forming apparatus 1. For example, the accommodating space may be provided at a position covered by the opening/closing member 83 (FIGS. 1A, 1B, and 2) located at the closed position.

### Assembly and Disassembly of Toner Pack

The operation of assembling and disassembling the toner pack 100 by attaching and detaching the nozzle unit 130 to and from the pouch unit 120 will be described in detail.

In the present example, the nozzle unit 130 can be attached to and detached from the pouch unit 120 by screwing and unscrewing the male screw portion 102m of the nozzle 102 into and from the female screw portion 122f of the connecting member 122.

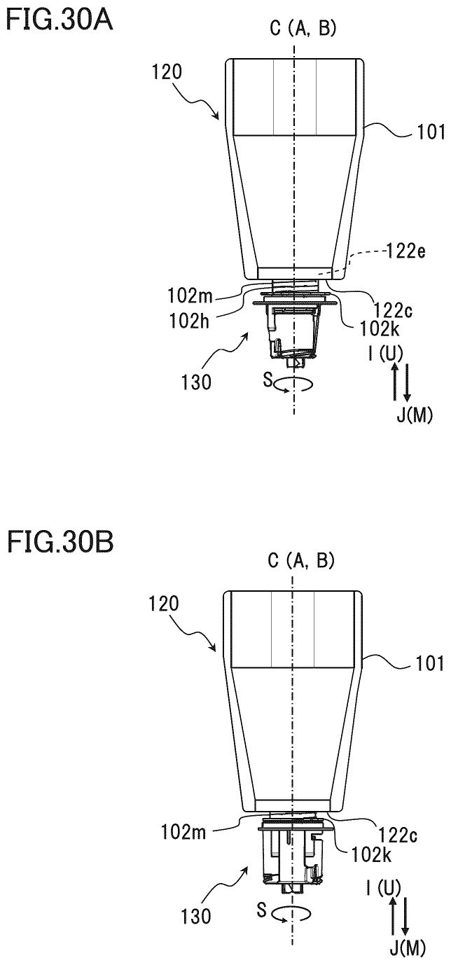

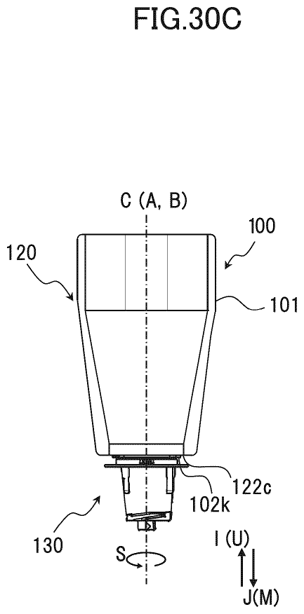

In a case where the nozzle unit 130 is attached to the pouch unit 120 to assemble the toner pack 100, the user aligns the inserting portion 102h of the nozzle 102 with the inserted portion 122e of the connecting member 122 as illustrated in FIG. 30A. Then, the user rotates the nozzle 102 in a predetermined rotation direction S (screwing direction) around the axis C to screw the male screw portion 102m of the nozzle 102 into the female screw portion 122f of the connecting member 122. As the male screw portion 102m and the female screw portion 122f are screwed together, the nozzle 102 moves relative to the connecting member 122 in the insertion direction I as illustrated in FIGS. 30B and 30C. Then, as illustrated in FIG. 30C, when the nozzle 102 reaches the insertion completion position where the flange 102k of the nozzle 102 abuts against the facing portion 122c of the connecting member 122, the attaching of the nozzle unit 130 is completed.

As a gripping portion for enabling the user to easily grip the nozzle 102 when assembling and disassembling the toner pack 100, a projection 102k1 as illustrated in FIGS. 25A and 25B may be provided on the flange 102k of the nozzle 102. Instead of the projection 102k1, a non-slip uneven shape (notch) may be provided on the outer peripheral portion of the flange 102k. The projection 102k1 or the uneven shape may be provided in a portion other than the flange 102k of the nozzle 102.

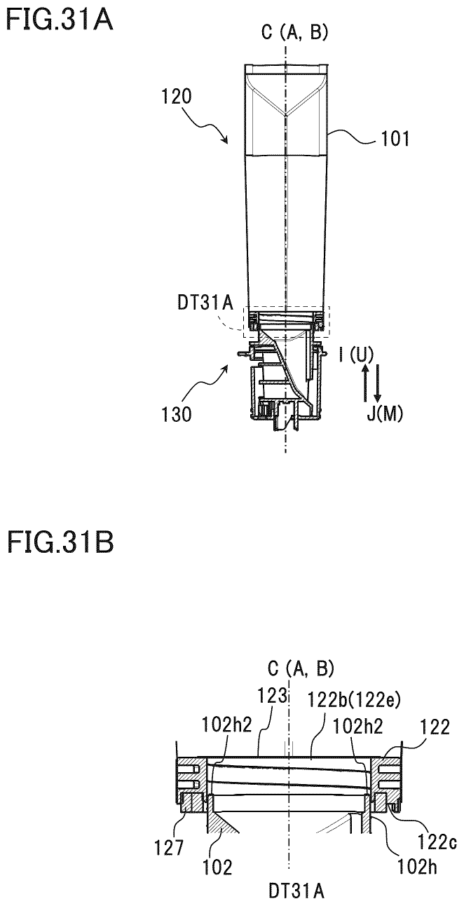

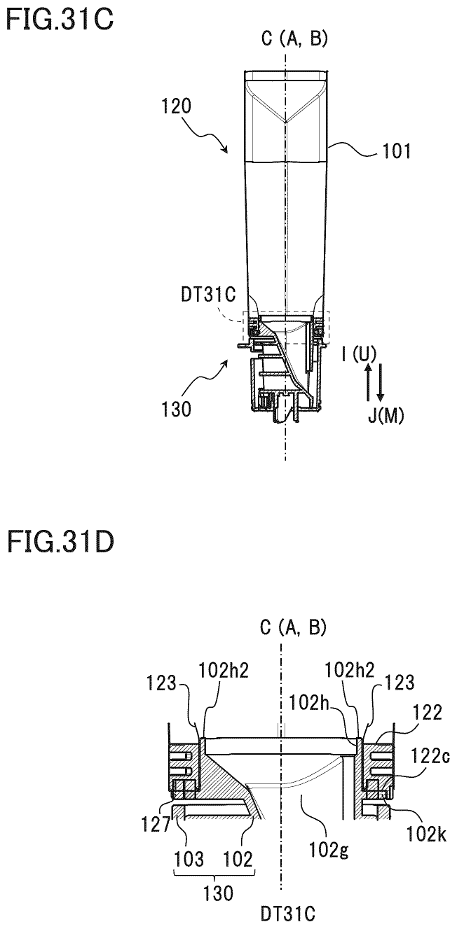

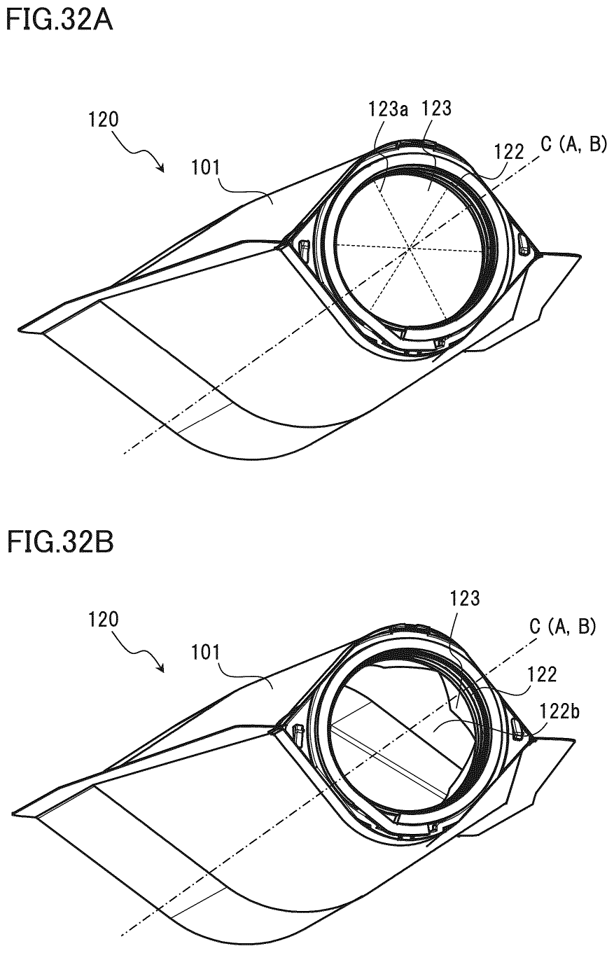

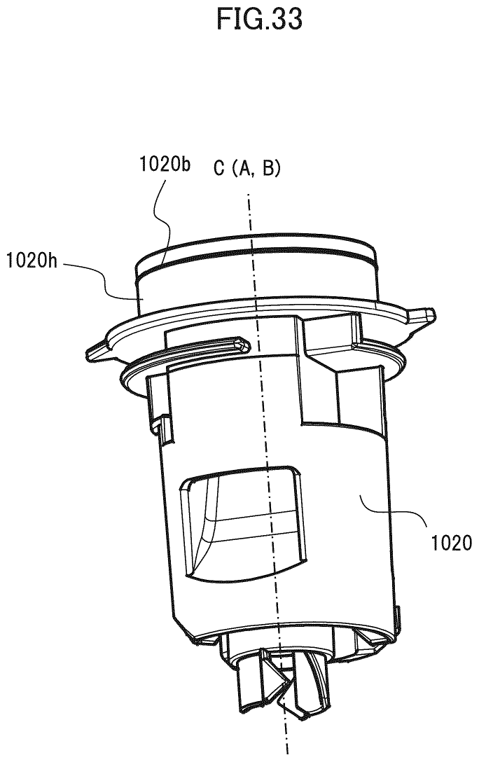

It will be described that, in the process of assembling the toner pack 100 as described above, the developer seal 123 of the sealed pouch unit 120 is torn, and the sealing of the toner in the pouch 101 is released. FIG. 31A is a cross-sectional view of the toner pack 100 according to Example 1 before being assembled. FIG. 31B is an enlarged view of a rectangular region DT31A in FIG. 31A. FIG. 31C is a cross-sectional view of the toner pack 100 according to Example 1 after being assembled. FIG. 31D is an enlarged view of a rectangular region DT31C in FIG. 31C. FIG. 32A is a perspective view of the pouch unit 120 before the developer seal 123 is torn. FIG. 32B is a perspective view of the pouch unit 120 in a state where the developer seal 123 is torn.

As illustrated in FIGS. 31A, 31B, and 32A, before the nozzle unit 130 is attached to the pouch unit 120, the developer seal 123 covers the entire region of the through hole 122b of the connecting member 122. Therefore, in the pouch unit 120, the opening portion 101b of the pouch 101 is closed by the developer seal 123 and the connecting member 122, and the toner is sealed in the accommodating space of the pouch 101.

As illustrated in FIGS. 31C and 31D, when the nozzle unit 130 is attached to the pouch unit 120, an end surface 102h2 of the inserting portion 102h of the nozzle 102 comes into contact with the developer seal 123 before the nozzle 102 reaches the insertion completion position. When the nozzle 102 is further inserted in the insertion direction I, the inserting portion 102h breaks through the developer seal 123 (FIG. 32B). As a result, the pouch unit 120 is in an unsealed state in which at least a part of the opening portion 101b of the pouch 101 is opened, and the accommodating space in the pouch 101 communicates with the discharge passage 102g of the nozzle 102. That is, the end surface 102h2 of the inserting portion 102h is an example of an unsealing means or an unsealing member that releases the sealing of the developer by the sealing member so as to allow the accommodating space of the container unit and the discharge passage of the discharge passage forming unit to communicate with each other in the process of attaching the discharge passage forming unit to the container unit.

As illustrated in FIG. 32A, it is preferable that a pre-cut portion 123a is provided in advance in the developer seal 123. The pre-cut portion 123a is a region processed such that the developer seal 123 is easily torn as compared with the other regions. For example, in a case where a sheet material including a plurality of layers is used as the developer seal 123, the pre-cut portion 123a is formed by cutting at least one of the layers in a perforated manner. The pre-cut portion 123a of the present example is disposed radially about the axis C.

By providing the pre-cut portion 123a, when the developer seal 123 is torn by the inserting portion 102h, the developer seal 123 can be torn along the pre-cut portion 123a. Therefore, it is possible to reduce the possibility that the developer seal 123 is torn in an irregular shape, and the opening portion 101b of the pouch 101 is not sufficiently opened, which hinders the smooth discharge of the toner from the toner pack 100.

The method for unsealing the developer seal 123 is not limited thereto, and the nozzle unit 130 may be connected to the pouch unit 120 after the user simply peels off the developer seal 123 from the connecting member 122.

Even after the sealing of the pouch unit 120 is released in the process of assembling the toner pack 100, the discharge port 102a of the nozzle 102 is blocked by the above-described pack-side seal 105 (the pack-side shutter 103), and the toner is sealed inside the toner pack 100. Thereafter, by attaching the toner pack 100 to the attaching part 106 of the image forming apparatus 1, and operating the operation lever 108 from the closed position to the opened position, the discharge port 102a is opened, and the toner is supplied from the toner pack 100 to the developing container 32 inside the image forming apparatus 1. After the supply of the toner is completed, by rotating the operation lever 108 from the opened position to the closed position, the discharge port 102a is closed back by the pack-side seal 105 (the pack-side shutter 103). Then, the toner pack 100 can be detached from the attaching part 106 of the image forming apparatus 1.

In a case where the nozzle unit 130 is detached from the pouch unit 120 to disassemble the toner pack 100, the user rotates the nozzle 102 around the axis C in a direction opposite to the rotation direction S (the screwing direction) described above. As a result, the screwing of the male screw portion 102m of the nozzle 102 and the female screw portion 122f of the connecting member 122 is released. As the screwing of the male screw portion 102m and the female screw portion 122f is loosened, the nozzle 102 moves relative to the connecting member 122 in the detachment direction J so as to change from the state of FIG. 30C to the state of FIG. 30A through the state of FIG. 30B. Then, when the inserting portion 102h comes out of the inserted portion 122e as illustrated in FIG. 30A, the detachment of the nozzle unit 130 is completed.

### Advantages of Present Example

In the present example, the nozzle unit 130 can be attached to and detached from the pouch unit 120 by engaging and disengaging the male screw portion 102m serving as an engaging portion of the nozzle 102 with and from the female screw portion 122f serving as an engaged portion of the connecting member 122. Therefore, by attaching the nozzle unit 130 detached from the used toner pack 100 to a sealed pouch unit 120, it is possible to assemble a new toner pack 100 that can be newly used (that can supply toner to the image forming apparatus 1).

In this manner, by configuring the nozzle unit 130 of the toner pack 100 to be reusable, the user only needs to purchase a sealed pouch unit 120 at a second or subsequent time when toner is supplied, and does not need to purchase an entire toner pack 100 including a nozzle unit 130. Therefore, a new nozzle unit 130 is not required every time toner is supplied, making it possible to reduce the amount of material (the amount of resin used), and reduce the cost. In addition, the toner for replenishment can be provided to the user at a lower cost, and the running cost can be reduced.

In the present example, when the nozzle unit 130 is attached to the sealed pouch unit 120, the sealing of the developer seal 123 serving as a sealing member is automatically released. The toner pack 100 may be assembled after the user peels off the developer seal 123. However, if the sealing is automatically released when the nozzle unit 130 is attached, the possibility of toner leakage during assembly can be reduced.

In addition, since the screwing engagement between the screw portions is adopted as a method of engagement between the engaging portion and the engaged portion, a general user can easily attach and detach the nozzle unit 130, improving usability.

### Modification

In Example 1, it has been described that the user assembles and disassembles the toner pack 100. However, the used toner pack 100 may be collected from the user, and the toner pack 100 may be refilled with toner and the refilled toner pack 100 may be sold (refill type). Even in this case, according to the present example, the nozzle unit 130 can be attached and detached by engaging and disengaging the engaging portion of the nozzle 102 and the engaged portion of the connecting member 122, making it easier to refill the toner. That is, the through hole 122b of the connecting member 122 is exposed by detaching the nozzle unit 130 from the collected toner pack 100, making it easier to refill the toner through the through hole 122b than refilling the toner through the discharge port 102a. In the refill type, a tape or a film may be attached so as to cover the boundary between the nozzle 102 and the connecting member 122 so that the user does not accidentally detach the nozzle unit 130.

In addition, the configuration of the unsealing means (unsealing member) that automatically releases the sealing of the sealing member when the nozzle unit 130 is attached is not limited to the configuration in which the end surface 102h2 of the inserting portion 102h of the nozzle 102 breaks through the developer seal 123. For example, a valve body pressed against the through hole 122b of the connecting member 122 by a biasing force of a spring or the like may be used as the sealing member, and the inserting portion 102h of the nozzle 102 may lift the valve body against the biasing force when the nozzle unit 130 is attached. In addition, a shutter member that moves with respect to an opening provided inside the pouch unit 120 may be provided as the sealing member, and the inserting portion 102h of the nozzle 102 may move the shutter when the nozzle unit 130 is attached.

In Example 1, the female screw portion 122f is provided in the inner peripheral surface 122d of the inserted portion 122e of the pouch unit 120, and the male screw portion 102m is provided on the surface facing the inner peripheral surface 122d of the inserting portion 102h of the nozzle unit 130, but the present disclosure is not limited thereto. For example, a female screw portion may be formed in the inner peripheral surface of the inserting portion 102h of the nozzle unit 130, and a male screw portion may be formed on the outer peripheral surface (the surface facing the inner peripheral surface) of the inserted portion 122e of the pouch unit 120. That is, one of the engaging portion and the engaged portion may be a male screw portion, and the other of the engaging portion and the engaged portion may be a female screw portion screwed with the male screw portion.

In addition, a plurality of types of pouch units 120 on which the nozzle unit 130 can be attached may be prepared. The plurality of types of pouch units 120 differ from each other in amount of toner contained therein. For example, and the user can select any one of them depending on how often the image forming apparatus 1 is used or the like. In this case as well, the nozzle unit 130 common to the plurality of types of pouch units 120 can be reused.

In Example 1, the pack-side shutter 103 and the apparatus-side shutter 109 are configured to be rotatable between the shielding position and the opening position about the rotation axes A and B, but the present disclosure is not limited thereto. For example, the pack-side shutter 103 and the apparatus-side shutter 109 may be configured to be movable between the shielding position and the opening position by linearly moving in parallel with the detachment direction J.

In addition, in Example 1, the pack-side shutter 103 is configured to open the discharge port 102a of the nozzle 102 only at the opening position, but the present disclosure is not limited thereto. For example, the pack-side shutter 103 may be a rotary member that opens the discharge port 102a of the nozzle 102 regardless of the rotation position. At this time, the discharge port 102a of the nozzle 102 may be configured to be closed by a seal when the toner pack 100 is not attached to the attaching part 106, and the seal may be detached while or after the toner pack 100 is attached to the attaching part 106.

The toner pack 100 may not include the pack-side shutter 103. For example, a seal may be attached so as to close the discharge port 102a of the nozzle 102, and the user may peel off the seal immediately before using the toner pack 100.

### Example 2

Example 2 of the present disclosure will be described with reference to FIGS. 33 to 36D. A toner pack 100A serving as a developer supply container of the present example basically has the same configurations as those in Example 1 except for a configuration for engagement between a nozzle 1020 and a connecting member 1220 to be described below, and can be used to supply toner to the image forming apparatus 1 described in Example 1. Hereinafter, unless otherwise specified, elements denoted by the same reference signs as those in Example 1 have substantially the same configurations and functions as those described in Example 1.

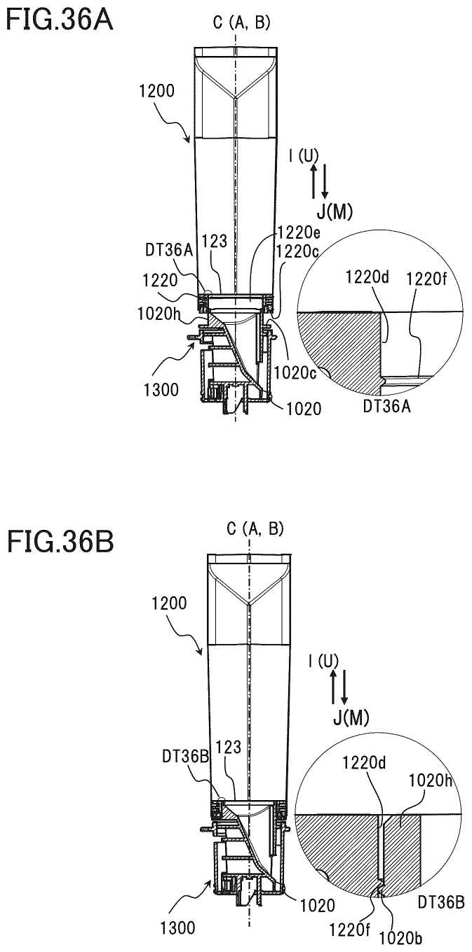

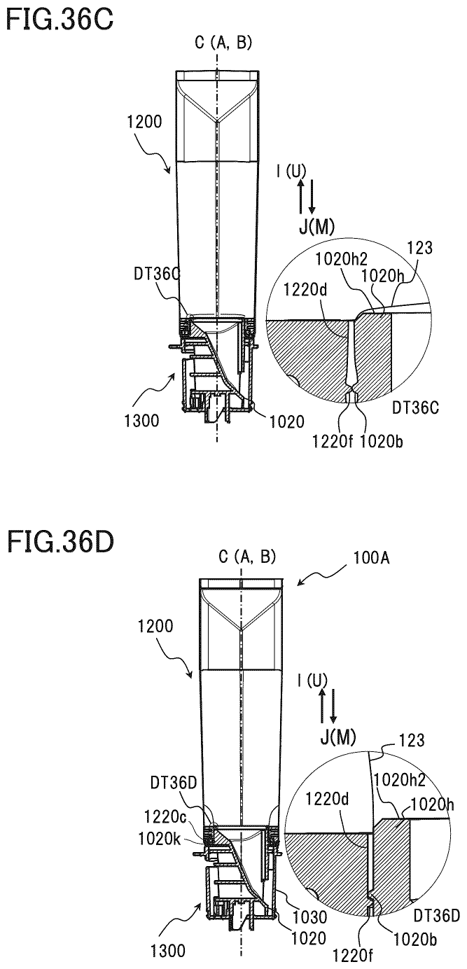

As in Example 1, the toner pack 100A (FIG. 36D) of the present example includes a pouch unit 1200 and a nozzle unit 1300. The pouch unit 1200 includes a pouch 101 and a connecting member 1220. The nozzle unit 1300 includes a nozzle 1020 and a pack-side shutter 103.

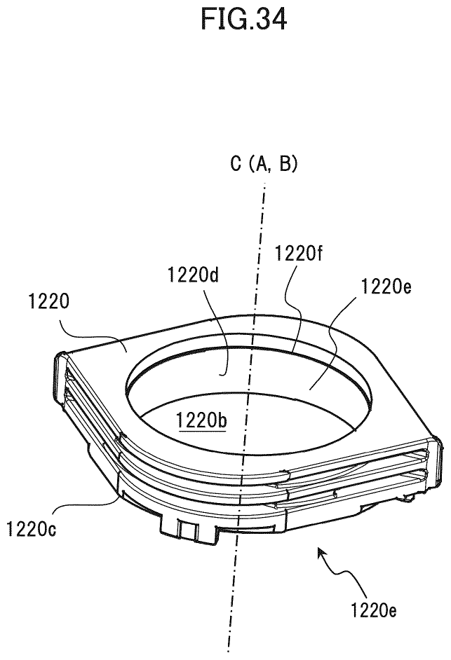

FIG. 33 is a perspective view of the nozzle 1020. FIG. 34 is a perspective view of the connecting member 1220 according to Example 2.

As illustrated in FIG. 33, the nozzle 1020 has an inserting portion 1020h and an outward protrusion 1020b serving as an engaging portion provided on the inserting portion 1020h. As illustrated in FIG. 34, the connecting member 1220 includes an inner peripheral surface 1220d forming a through hole 1220b, and an inward protrusion 1220f serving as an engaged portion provided on the inner peripheral surface 1220d. The inner peripheral surface 1220d including the inward protrusion 1220f forms an inserted portion 1220e into which the inserting portion 1020h is inserted.

The inserting portion 1020h of the nozzle 1020 can be fitted to the inner peripheral surface 1220d of the connecting member 1220, and is smaller than the diameter of the inner peripheral surface 1220d. The outward protrusion 1020b is a portion protruding so as to have an outer diameter larger than the outer peripheral surface of the inserting portion 1020h having a substantially cylindrical shape. In addition, the inward protrusion 1220f of the connecting member 1220 is a portion protruding so as to have an inner diameter smaller than the inner peripheral surface 1220d of the through hole 1220b having a substantially cylindrical shape. The inner diameter of the inward protrusion 1220f is slightly smaller than the outer diameter of the outward protrusion 1020b.

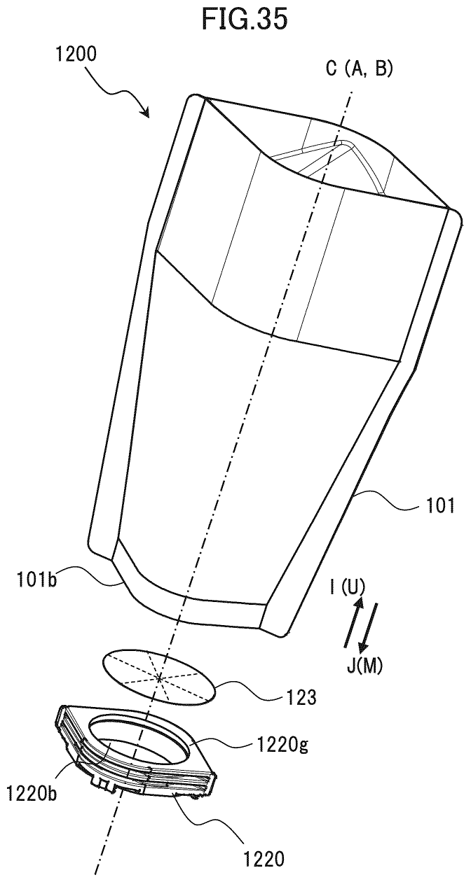

A toner supply method according to the present example will be described with reference to FIGS. 35 to 36D. FIG. 35 is an exploded perspective view of the pouch unit 1200 serving as a container unit of a developer supply container. FIGS. 36A to 36D are cross-sectional views illustrating a state the toner pack 100A is being assembled, and circles in the lower right ends of FIGS. 36A to 36D are enlarged views of regions DT36A, DT36B, DT36C, and DT36D in the cross-sectional views, respectively.

As illustrated in FIG. 35, the sealed pouch unit 1200 includes a pouch 101, a connecting member 1220, and a developer seal 123. The developer seal 123 is attached in a closely adhering state to an end surface 1220g in the insertion direction I of the connecting member 1220 by adhesion or another method to seal the through hole 1220b. Therefore, in a state where the outer peripheral portion 122a of the connecting member 1220 is joined to the opening portion 101b of the pouch 101, the entire region of the opening portion 101b is closed by the connecting member 1220 and the developer seal 123, and the toner in the pouch 101 is sealed.

When the remaining amount of the toner in the process unit 20 becomes low, the user can purchase a sealed pouch unit 1200 and assemble the toner pack 100A by combining the sealed pouch unit 1200 with the nozzle unit 1300 owned by the user. To assemble the toner pack 100A, the nozzle unit 1300 detached from the used toner pack 100A may be attached to the sealed pouch unit 1200. Then, the user attaches the assembled toner pack 100A on the attaching part 106 of the image forming apparatus 1 to supply toner to the developing container 32 serving as a developer storage inside the image forming apparatus.

When assembling the toner pack 100A, as illustrated in FIG. 36A, the user aligns the inserting portion 1020h of the nozzle 1020 with the inserted portion 1220e of the connecting member 1220, and pushes the nozzle unit 1300 into the connecting member 1220 in the insertion direction I. The nozzle unit 1300 transitions from the state of FIG. 36A to the state of FIG. 36B, the state of FIG. 36C, and the state of FIG. 36D while the inserting portion 1020h and the inserted portion 1220e maintains a coaxial positional relationship with the axis C as a common axis.

As illustrated in the circles (DT36A to DT36D) in the lower right ends of FIGS. 36A to 36D, as the inserting portion 1020h moves in the insertion direction I, the outward protrusion 1020b of the inserting portion 1020h abuts on the inward protrusion 1220f of the inserted portion 1220e (FIG. 36B). When the nozzle unit 1300 is further pushed in the insertion direction I from this state, at least one of the outward protrusion 1020b and the inward protrusion 1220f is elastically deformed (FIG. 36C). Then, the outward protrusion 1020b climbs over the inward protrusion 1220f in the insertion direction I (FIG. 36D).

When the nozzle unit 1300 is inserted to a position (an insertion completion position) where the facing portion 1220c of the connecting member 1220 and the flange 1020k of the nozzle 1020 abuts against each other (FIG. 36D), the attaching of the nozzle unit 1300 is completed.

In the process of assembling the toner pack 100A as described above, the end surface 1020h2 in the insertion direction I of the inserting portion 1020h of the nozzle 1020 comes into contact with the developer seal 123 and breaks through the developer seal 123 as illustrated in FIGS. 36C and 36D. As a result, at least a part of the opening portion 101b of the pouch 101 (at least a part of the through hole 1220b) is opened, and the sealing of the toner contained in the pouch 101 is released. The toner supply method using the assembled toner pack 100A is the same as that in Example 1, and thus the description thereof will be omitted.

When detaching the nozzle unit 1300 from the pouch unit 1200 to disassemble the toner pack 100A, the user may pull out the nozzle unit 1300 from the connecting member 1220 in the detachment direction J. As a result, the nozzle unit 1300 transitions from the state of FIG. 36D to the state of FIG. 36C, the state of FIG. 36B, and the state of FIG. 36A in the reverse order of assembly. That is, at least one of the outward protrusion 1020b and the inward protrusion 1220f is elastically deformed (FIG. 36C), and the outward protrusion 1020b climbs over the inward protrusion 1220f in the detachment direction J (FIG. 36B). Then, when the inserting portion 1020h comes out of the inserted portion 1220e as illustrated in FIG. 36A, the detachment of the nozzle unit 1300 is completed.

### Advantages of Present Example

In the present example, the nozzle unit 1300 can be attached to and detached from the pouch unit 1200 by engaging and disengaging the outward protrusion 1020m serving as an engaging portion of the nozzle 1020 with and from the inward protrusion 1220f serving as an engaged portion of the connecting member 1220. Therefore, by attaching the nozzle unit 1300 detached from the used toner pack 100A to a sealed pouch unit 1200, it is possible to assemble a new toner pack 100A that can be newly used (that can supply toner to the image forming apparatus 1).

Therefore, similarly to Example 1, a new nozzle unit 130 is not required every time toner is supplied, making it possible to reduce the amount of material (the amount of resin used), and reduce the cost. In addition, the toner for replenishment can be provided to the user at a lower cost, and the running cost can be reduced.

In the present example, when the nozzle unit 1300 is attached to the sealed pouch unit 1200, the sealing of the developer seal 123 serving as a sealing member is automatically released. The toner pack 100A may be assembled after the user peels off the developer seal 123. However, if the sealing is automatically released when the nozzle unit 1300 is attached, the possibility of toner leakage during assembly can be reduced.

In addition, since the press-fitting between the outward protrusion 1020m and the inward protrusion 1220fis adopted as a method of engagement between the engaging portion and the engaged portion, a general user can easily attach and detach the nozzle unit 1300, improving usability.

### Modifications

In Example 2, the inward protrusion 1220f is provided on the inner peripheral surface 1220d of the inserted portion 1220e of the pouch unit 1200, and the outward protrusion 1020m is provided on the surface facing the inner peripheral surface 1220d of the inserting portion 1020h of the nozzle unit 1300, but the present disclosure is not limited thereto. For example, an inward protrusion may be formed on the inner peripheral surface of the inserting portion 1020h of the nozzle unit 1300, and an outward protrusion may be formed on the outer peripheral surface (the surface facing the inner peripheral surface) of the inserted portion 122e of the pouch unit 120. That is, it is only required that one of the engaging portion and the engaged portion is an inward protrusion provided on the inner peripheral surface of the hole communicating with the opening portion, the other of the engaging portion and the engaged portion is an outward protrusion provided on the surface facing the inner peripheral surface, and the outer diameter of the outward protrusion is larger than the inner diameter of the inward protrusion.

In the present example as well, the used toner pack 100A may be collected, refilled, and then sold (refill type). In addition, the configurations described in the modifications of Example 1 may be applied to Example 2.

### Example 3

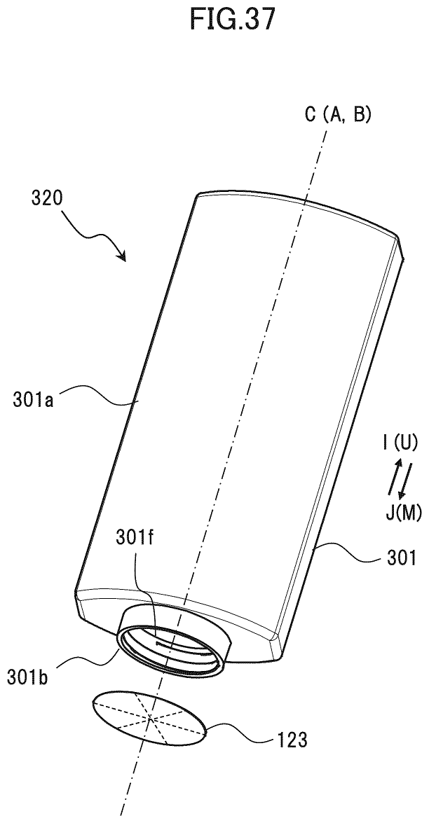

Example 3 of the present disclosure will be described with reference to FIGS. 37 to 40D. A toner pack 100B serving as a developer supply container of the present example basically has the same configurations as those in Example 1 except that the material, shape, and the like of a bottle 301 serving as a containing member are different from those of the pouch 101 in Example 1. The toner pack 100B can be used to supply toner to the image forming apparatus 1 described in Example 1. Hereinafter, unless otherwise specified, elements denoted by the same reference signs as those in Example 1 have substantially the same configurations and functions as those described in Example 1.

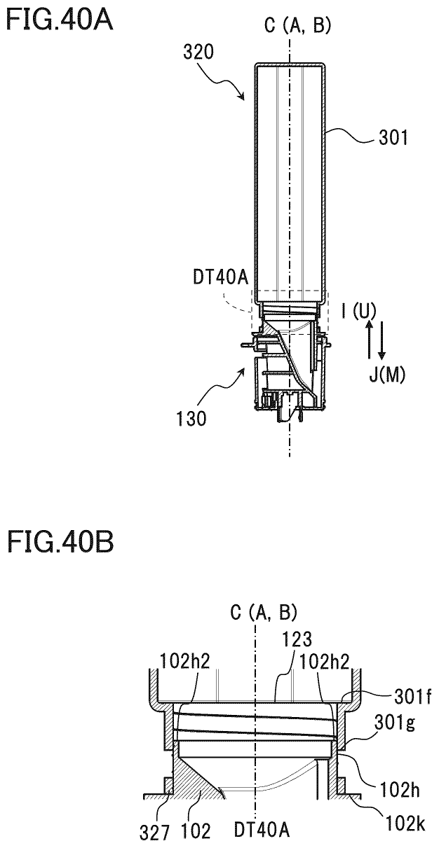

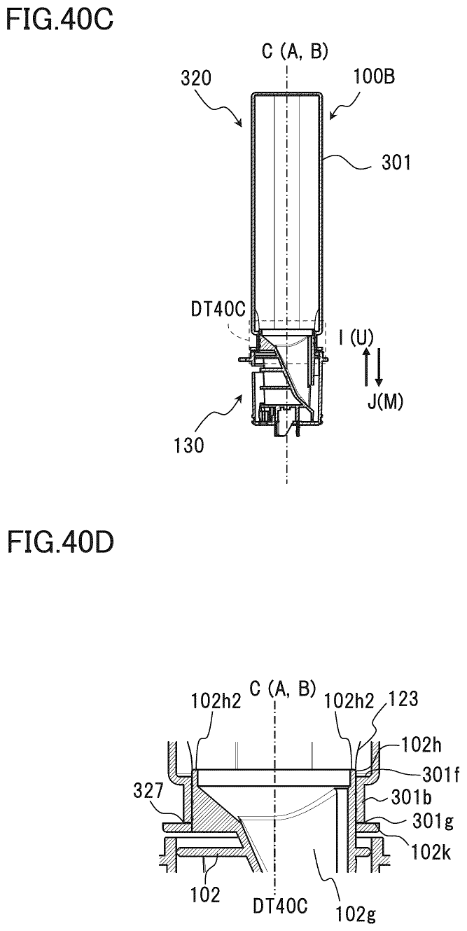

The toner pack 100B (FIG. 40A) of the present example includes a bottle unit 320 and a nozzle unit 130.

FIG. 37 is an exploded perspective view of the bottle unit 320 according to Example 3. As illustrated in FIG. 37, the sealed bottle unit 320 includes a bottle 301 and a developer seal 123.

The bottle 301 has a container shape with one end portion in a direction following the axis C thereof being open. The bottle 301 includes an accommodating portion 301a that forms an accommodating space for accommodating toner, and an opening portion 301b at which the accommodating portion 301a is open on one side in the direction following the axis C.

The material of the bottle 301 is, for example, polystyrene (PS), polypropylene (PP), or acrylonitrile butadiene styrene copolymer resin (ABS). The thickness of the bottle 301 is set to, for example, about 0.9 mm to 1.5 mm. In the present example, it is not assumed that the user deforms the containing member by hand to reduce the volume as in Example 1, and the toner in the bottle 301 is discharged by gravity. However, by setting the thickness of the bottle 301 to 1 mm or less, preferably 500 μm or less, the accommodating portion 301a of the bottle 301 may be deformed by the user's hand, so that the toner contained therein can be easily discharged.

The developer seal 123 is attached in a closely adhering state to a bonding surface 301f (see FIG. 40B as well) provided in the accommodating portion 301a of the bottle 301 by adhesion or another method to seal the opening portion 301b. In a state where the developer seal 123 is attached, the entire region of the opening portion 301b of the bottle 301 is closed by the developer seal 123, and the toner is sealed in the accommodating portion 301a, so that the toner does not flow out from the opening portion 301b.

The nozzle 102 is attached to the bottle unit 320 by being engaged with the opening portion 301b of the bottle 301. The nozzle 102 and the nozzle unit 130 having the same configurations as those in Example 1 can be used.

When the remaining amount of the toner in the process unit 20 becomes low, the user can purchase a sealed bottle unit 320 and assemble the toner pack 100B by combining the sealed bottle unit 320 with the nozzle unit 130 owned by the user. To assemble the toner pack 100B, the nozzle unit 130 detached from the used toner pack 100B may be attached to the sealed bottle unit 320. Then, the user attaches the assembled toner pack 100B on the attaching part 106 of the image forming apparatus 1 to supply toner to the developing container 32 serving as a developer storage inside the image forming apparatus.

Assuming that the nozzle unit 130 cannot be reused due to damage or the like or the user does not have the nozzle unit 130 on hand, the nozzle unit 130 may be sold alone. Whether to purchase a new toner pack 100B with a nozzle unit 130 attached to a bottle unit 320 or to purchase a sealed bottle unit 320 may be selected by the user. Further, a sealed bottle unit 320 and a nozzle unit 130 may be sold together. The set of the sealed bottle unit 320 and the nozzle unit 130 is an example of a developer supply container set that can be used as a developer supply container by attaching the nozzle unit 130 serving as a discharge passage forming unit to the bottle unit 320 serving as a container unit. In addition, the nozzle unit 130 can also be sold together with the image forming apparatus 1.

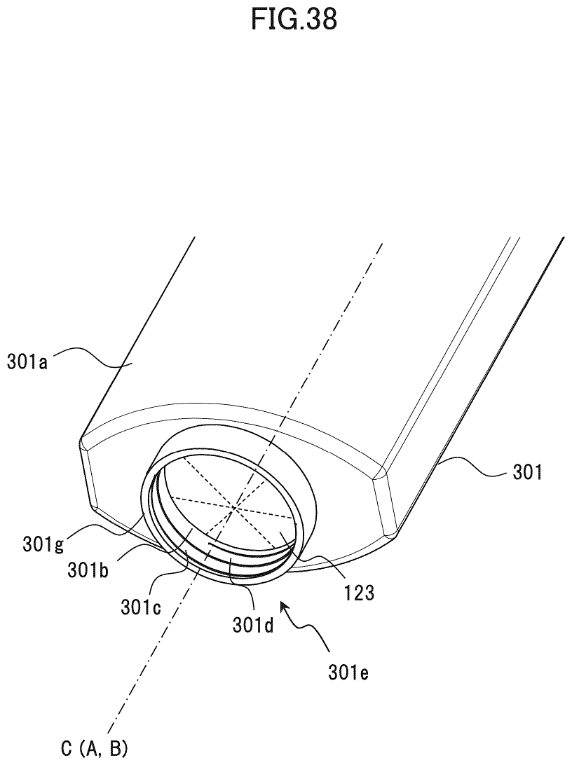

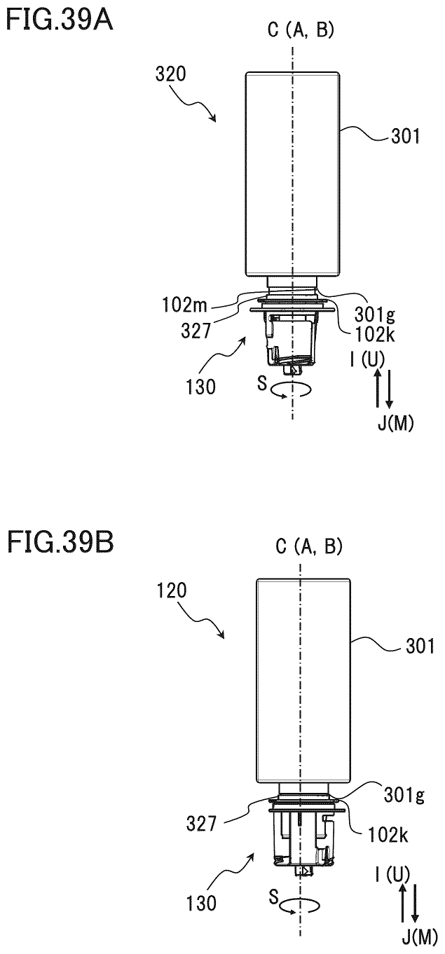

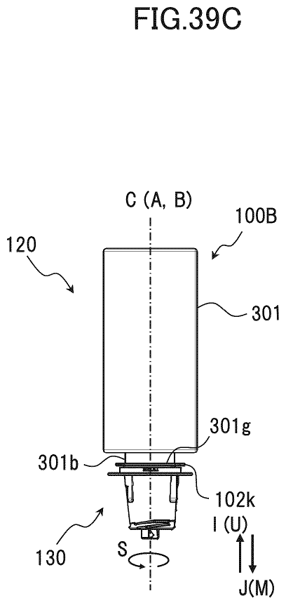

A method for assembling the toner pack 100B according to the present example will be described with reference to FIGS. 38 to 40D. FIG. 38 is a perspective view illustrating the periphery of the opening portion 301b of the sealed bottle unit 320. FIG. 39A is a side view of the toner pack 100B before being assembled. FIG. 39B is a side view of the toner pack 100B while being assembled. FIG. 39C is a side view illustrating the toner pack 100B after being assembled.

As illustrated in FIG. 38, the opening portion 301b of the bottle 301 is open toward the detachment direction J, and includes an inner peripheral surface 301c having an axis C parallel to the detachment direction J as a central axis. A female screw portion 301d serving as an engaged portion is formed in the inner peripheral surface 301c. The inner peripheral surface 301c including the female screw portion 301d constitutes an inserted portion 301e into which the inserting portion 102h (FIG. 40B) of the nozzle 102 is inserted.

The inserting portion 102h of the nozzle 102 has a male screw portion 102m (FIGS. 24A, 24B, and 39A) similar to that in Example 1. The male screw portion 102m serving as an engaging portion of the nozzle 102 and the female screw portion 301d serving as an engaged portion of the bottle 301 are formed so as to be screwed with each other. Therefore, the nozzle 102 can be attached to and detached from the bottle 301 by engaging and disengaging the male screw portion 102m with and from the female screw portion 301d. Furthermore, the nozzle unit 130 can be attached to and detached from the bottle unit 320 by engaging and disengaging the male screw portion 102m with and from the female screw portion 301d.

In a case where the nozzle unit 130 is attached to the bottle unit 320 to assemble the toner pack 100B, the user aligns the inserting portion 102h of the nozzle 102 with the inserted portion 301e of the bottle 301 as illustrated in FIGS. 39A, 40A, and 40B. Then, the user rotates the nozzle 102 in a predetermined rotation direction S (screwing direction) around the axis C to screw the male screw portion 102m of the nozzle 102 to the female screw portion 301d of the bottle 301. As the male screw portion 102m and the female screw portion 122f are screwed together, the nozzle 102 moves relative to the bottle 301 in the insertion direction I as illustrated in FIGS. 39B and 39C. Then, when the nozzle 102 reaches the insertion completion position as illustrated in FIGS. 39C, 40C, and 40D, the attaching of the nozzle unit 130 is completed. The insertion completion position is a position where the flange 102k of the nozzle 102 abuts against a facing portion 301g, which is an end surface on the upstream side in the insertion direction I of the opening portion 301b of the bottle 301.

It will be described that, in the process of assembling the toner pack 100B as described above, the developer seal 123 of the sealed bottle unit 320 is torn, and the sealing of the toner in the bottle 301 is released. FIG. 40A is a cross-sectional view of the toner pack 100B before being assembled. FIG. 40B is a partially enlarged view in which a rectangular region DT40A in FIG. 40A is enlarged. FIG. 40C is a cross-sectional view illustrating the toner pack 100B after being assembled. FIG. 40D is a partially enlarged view in which a rectangular region DT40C in FIG. 40C is enlarged.

As illustrated in FIGS. 40A and 40B, before the nozzle unit 130 is attached to the pouch unit 120, the developer seal 123 covers the entire region of the opening portion 301b of the bottle 301. Therefore, the bottle unit 320 is in a sealed state in which the opening portion 301b of the bottle 301 is closed by the developer seal 123, and the accommodating space in the bottle 301 is isolated from the external space.

As illustrated in FIGS. 40C and 40D, when the nozzle unit 130 is attached to the bottle unit 320, an end surface 102h2 of the inserting portion 102h of the nozzle 102 comes into contact with the developer seal 123 before the nozzle 102 reaches the insertion completion position. When the nozzle 102 is further inserted in the insertion direction I, the inserting portion 102h breaks through the developer seal 123 (FIG. 40D). As a result, the bottle unit 320 is in an unsealed state in which at least a part of the opening portion 301b of the bottle 301 is opened, and the accommodating space in the bottle 301 communicates with the discharge passage 102g of the nozzle 102. That is, the end surface 102h2 of the inserting portion 102h is an example of an unsealing means or an unsealing member that releases the sealing of the developer by the sealing member so as to allow the accommodating space of the container unit and the discharge passage of the discharge passage forming unit to communicate with each other in the process of attaching the discharge passage forming unit to the container unit. The toner supply method using the assembled toner pack 100B is the same as that in Example 1, and thus the description thereof will be omitted.

In a case where the nozzle unit 130 is detached from the bottle unit 320 to disassemble the toner pack 100B, the user rotates the nozzle 102 around the axis C in a direction opposite to the rotation direction S (the screwing direction) described above. As a result, the screwing of the male screw portion 102m of the nozzle 102 and the female screw portion 301d of the bottle 301 is released. As the screwing of the male screw portion 102m and the female screw portion 301d is loosened, the nozzle 102 moves relative to the bottle 301 in the detachment direction J. Then, when the inserting portion 102h comes out of the inserted portion 122e, the detachment of the nozzle unit 130 is completed.

As illustrated in FIG. 40A, it is preferable to place a seal member 327 in an annular shape so as to surround the outer periphery of the opening portion 301b between the flange 102k of the nozzle 102 and the facing portion 301g of the bottle 301. The seal member 327 is, for example, a rubber-like or sponge-like elastic member attached to a boundary portion between the outer peripheral surface of the inserting portion 102h and the flange 102k. As illustrated in FIG. 40D, the seal member 327 is compressed in the insertion direction I between the flange 102k and the facing portion 301g in a state where the nozzle 102 is inserted to the insertion completion position. As a result, a space between the flange 102kand the facing portion 301g is sealed by the seal member 327, so that toner leakage can be prevented.

### Advantages of Present Example

In the present example, the nozzle unit 130 can be attached to and detached from the bottle unit 320 by engaging and disengaging the male screw portion 102m serving as an engaging portion of the nozzle 102 with and from the female screw portion 301d serving as an engaged portion of the bottle 301. Therefore, by attaching the nozzle unit 130 detached from the used toner pack 100B to a sealed bottle unit 320, it is possible to assemble a new toner pack 100B that can be newly used (that can supply toner to the image forming apparatus 1).

Therefore, similarly to Example 1, a new nozzle unit 130 is not required every time toner is supplied, making it possible to reduce the amount of material (the amount of resin used), and reduce the cost. In addition, the toner for replenishment can be provided to the user at a lower cost, and the running cost can be reduced.

In addition, in the present example, when the nozzle unit 130 is attached to the sealed bottle unit 320, the sealing of the developer seal 123 serving as a sealing member is automatically released. The toner pack 100B may be assembled after the user peels off the developer seal 123. However, if the sealing is automatically released when the nozzle unit 130 is attached, the possibility of toner leakage during assembly can be reduced. The configuration in which the sealing of the sealing member is automatically released when the nozzle unit 130 is attached is not limited to the configuration in which the end surface of the inserting portion 102h of the nozzle 102 breaks through the developer seal 123 as described in the modification of Example 1.

In addition, since the screwing engagement between the screw portions is adopted as a method of engagement between the engaging portion and the engaged portion, a general user can easily attach and detach the nozzle unit 130, improving usability.

### Modifications

In the present example, similarly to Example 1, the nozzle unit 130 is attached to the bottle unit 320 by engaging the male screw portion 102m serving as an engaging portion and the female screw portion 301d serving as an engaged portion, but the engagement method is not limited thereto. The press-fitting between the outward protrusion and the inward protrusion described in Example 2 may be used.

In the present example as well, the used toner pack 100B may be collected, refilled, and then sold (refill type). In addition, the configurations described in the modifications of Examples 1 and 2 may be applied to Example 3.

According to the present disclosure, new embodiments can be provided for a developer supply container, a developer supply container set, a container unit, and an image forming system.

### Other Embodiments

In any of the embodiments described above, toner used as a recording material (developer) in an electrophotographic image forming apparatus is contained in the pouch 101 of the toner pack 100, but the present disclosure is not limited thereto. The pouch 101 can accommodate powder or liquid other than toner. For example, the pouch 101 may accommodate an ink used as a recording material in an image forming apparatus such as an inkjet type image forming apparatus. In this case, by attaching the toner pack 100 including the pouch 101 accommodating the ink to the inkjet type image forming apparatus, the ink can be supplied to the ink accommodating portion in the image forming apparatus. The toner pack 100 including the pouch 101 containing the ink is an example of an ink supply container.

### INDUSTRIAL APPLICABILITY

The present disclosure is applicable to, for example, a developer supply container for supplying a developer to an image forming apparatus such as a printer, a copier, a facsimile, and a multifunction peripheral having these functions, a developer supply container set and a container unit each being usable as a developer supply container, and an image forming system that forms an image on a recording material.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A developer supply container comprising:
a container unit; and
a discharge passage forming unit attached to the container unit,
wherein the container unit includes
a containing member configured to form an accommodating space in which toner is accommodated and including an opening portion communicating with the accommodating space, and
a connecting member including a connected portion and an engaged portion, the connected portion being connected to the opening portion of the containing member,
wherein the discharge passage forming unit includes
an engaging portion configured to be engageable with the engaged portion, and
a discharge passage which is configured to communicate with the accommodating space via the opening portion and through which the toner can be discharged to an outside,
wherein the discharge passage forming unit is configured to be attachable to and detachable from the container unit in a direction in which the discharge passage forming unit and the container unit are to be aligned, by moving the discharge passage forming unit with respect to the container unit in the direction in which the discharge passage forming unit and the container unit are to be aligned, without rotating the discharge passage forming unit with respect to the container unit, and
wherein the discharge passage forming unit is configured to be detached from the container unit in a case where an engagement of the engaging portion with the engaged portion is released.

2. The developer supply container according to claim 1,
wherein at least one of the engaging portion and the engaged portion is configured to deform elastically when the engaging portion engages with the engaged portion.

3. The developer supply container according to claim 1,
wherein the engaging portion and the engaged portion are configured such that the engagement of the engaging portion with the engaged portion is released by moving the discharge passage forming unit with respect to the container unit in the direction in which the discharge passage forming unit and the container unit are to be aligned.

4. The developer supply container according to claim 1,
wherein one of the engaging portion and the engaged portion is an inward protrusion provided on an inner peripheral surface of a hole communicating with the opening portion,
wherein an other of the engaging portion and the engaged portion is an outward protrusion provided on a surface facing the inner peripheral surface, and
wherein an outer diameter of the outward protrusion is larger than an inner diameter of the inward protrusion.

5. The developer supply container according to claim 1,
wherein the connecting member includes an inserted portion,
wherein the discharge passage forming unit includes an inserting portion to be inserted into the inserted portion,
wherein the engaged portion is provided in the inserted portion, and
wherein the engaging portion is provided in the inserting portion.

6. The developer supply container according to claim 1,
wherein the container unit further includes a sealing member configured to seal the toner in the accommodating space by closing the opening portion in a state before the discharge passage forming unit is attached to the container unit, and
wherein the discharge passage forming unit further includes an unsealing means configured to release sealing of the toner by the sealing member so as to allow the accommodating space and the discharge passage to communicate with each other in a process of attaching the discharge passage forming unit to the container unit.

7. The developer supply container according to claim 6,
wherein the connecting member includes a first surface joined to the opening portion of the containing member, and a second surface joined to the sealing member.

8. The developer supply container according to claim 1,
wherein the containing member is a pouch formed of a synthetic resin sheet subjected to pouch processing.

9. The developer supply container according to claim 1,
wherein the connecting member has a through hole allowing the discharge passage and the accommodating space to communicate with each other inside the opening portion,
wherein the developer supply container further includes a seal member attached to at least one of the discharge passage forming unit and the connecting member, and
wherein the seal member has elasticity, is disposed so as to surround an outer periphery of the through hole, and is compressed by being sandwiched between the discharge passage forming unit and the connecting member.

10. The developer supply container according to claim 1,
wherein the connecting member has a through hole allowing the discharge passage and the accommodating space to communicate with each other inside the opening portion, and
wherein an opening area of the through hole in a state where the discharge passage forming unit is detached from the container unit is larger than an opening area of a discharge port at which the discharge passage is open toward the outside when the toner is discharged to the outside.

11. An image forming system comprising:
the developer supply container according to claim 1; and
an image forming apparatus including
an image forming means including a developer storage configured to store the toner, the image forming means configured to form an image on a recording material using the toner in the developer storage, and
an attaching part to which the developer supply container is attached,
wherein the developer storage is configured to be supplied with the toner from an outside of the image forming apparatus by attaching the developer supply container to the attaching part.

12. A developer supply container set comprising:
a container unit; and
a discharge passage forming unit,
wherein the developer supply container set is usable as a developer supply container in a case where the discharge passage forming unit is attached to the container unit,
wherein the container unit includes
a containing member configured to form an accommodating space in which toner is accommodated and including an opening portion communicating with the accommodating space,
a connecting member including a connected portion and an engaged portion, the connected portion being connected to the opening portion of the containing member, and
a sealing member configured to seal the toner in the accommodating space by closing the opening portion,
wherein the discharge passage forming unit includes
an engaging portion configured to be engageable with the engaged portion, and
a discharge passage which is configured to communicate with the accommodating space via the opening portion in a state where the discharge passage forming unit is attached to the container unit and through which the toner can be discharged to an outside, and
wherein the discharge passage forming unit is configured to be attachable to and detachable from the container unit in a direction in which the discharge passage forming unit and the container unit are to be aligned, by moving the discharge passage forming unit with respect to the container unit in the direction in which the discharge passage forming unit and the container unit are to be aligned, without rotating the discharge passage forming unit with respect to the container unit, and
wherein the discharge passage forming unit is configured to be detached from the container unit in a case where an engagement of the engaging portion with the engaged portion is released.

13. The developer supply container set according to claim 12,
wherein at least one of the engaging portion and the engaged portion is configured to deform elastically when the engaging portion engages with the engaged portion.

14. The developer supply container set according to claim 12,
wherein the engaging portion and the engaged portion are configured such that the engagement of the engaging portion with the engaged portion is released by moving the discharge passage forming unit with respect to the container unit in the direction in which the discharge passage forming unit and the container unit are to be aligned.

15. The developer supply container set according to claim 12,
wherein one of the engaging portion and the engaged portion is an inward protrusion provided on an inner peripheral surface of a hole communicating with the opening portion,
wherein an other of the engaging portion and the engaged portion is an outward protrusion provided on a surface facing the inner peripheral surface, and
wherein an outer diameter of the outward protrusion is larger than an inner diameter of the inward protrusion.

16. The developer supply container set according to claim 12,
wherein the connecting member includes an inserted portion,
the discharge passage forming unit includes an inserting portion to be inserted into the inserted portion,
wherein the engaged portion is provided in the inserted portion, and
wherein the engaging portion is provided in the inserting portion.

17. The developer supply container set according to claim 12,
wherein the discharge passage forming unit further includes an unsealing means configured to release sealing of the toner by the sealing member so as to allow the accommodating space and the discharge passage to communicate with each other in a process of attaching the discharge passage forming unit to the container unit.

18. The developer supply container set according to claim 12,
wherein the connecting member includes a first surface joined to the opening portion of the containing member, and a second surface joined to the sealing member.

19. The developer supply container set according to claim 12,
wherein the containing member is a pouch formed of a synthetic resin sheet subjected to pouch processing.

20. The developer supply container set according to claim 12,
wherein the connecting member has a through hole allowing the discharge passage and the accommodating space to communicate with each other inside the opening portion,
wherein the developer supply container further includes a seal member attached to at least one of the discharge passage forming unit and the connecting member, and
wherein the seal member has elasticity, is disposed so as to surround an outer periphery of the through hole, and is compressed by being sandwiched between the discharge passage forming unit and the connecting member.

21. A container unit usable as a developer supply container in a case where a discharge passage forming unit including an engaging portion is attached thereto, the container unit comprising:
a containing member configured to form an accommodating space in which toner is accommodated and including an opening portion communicating with the accommodating space;
a connecting member including a connected portion and an engaged portion, the connected portion being connected to the opening portion of the containing member, the engaged portion being configured to be engageable with the engaging portion; and
a sealing member configured to seal the toner in the accommodating space by closing the opening portion,
wherein the container unit is configured such that, in a state where the discharge passage forming unit is attached the container unit, a discharge passage provided in the discharge passage forming unit communicates with the accommodating space via the opening portion so that the toner can be discharged to an outside via the discharge passage,
wherein the container unit is configured such that the discharge passage forming unit is attachable to and detachable from the container unit in a direction in which the discharge passage forming unit and the container unit are to be aligned, by moving the discharge passage forming unit with respect to the container unit in the direction in which the discharge passage forming unit and the container unit are to be aligned, without rotating the discharge passage forming unit with respect to the container unit, and
wherein the container unit is configured such that the discharge passage forming unit is detached from the container unit in a case where an engagement of the engaging portion with the engaged portion is released.

22. The container unit according to claim 21,
wherein the engaged portion is configured such that the engagement of the engaging portion with the engaged portion is released by moving the discharge passage forming unit with respect to the container unit in the direction in which the discharge passage forming unit and the container unit are to be aligned.

23. The container unit according to claim 21,
wherein the connecting member includes a first surface joined to the opening portion of the containing member, and a second surface joined to the sealing member.

24. The container unit according to claim 21,
wherein the containing member is a pouch formed of a synthetic resin sheet subjected to pouch processing.

25. The container unit according to claim 21,
wherein the connecting member has a through hole allowing the discharge passage and the accommodating space to communicate with each other inside the opening portion,
wherein the container unit further includes a seal member attached to the connecting member, and
wherein the seal member has elasticity, is disposed so as to surround an outer periphery of the through hole, and is configured to be compressed by being sandwiched between the discharge passage forming unit and the connecting member.

26. A developer supply container set comprising:
a container unit; and
a discharge passage forming unit,
wherein the developer supply container set is usable as a developer supply container in a case where the discharge passage forming unit is attached to the container unit,
wherein the container unit includes
an engaged portion,
a containing member configured to form an accommodating space in which toner is accommodated and including an opening portion communicating with the accommodating space, and
a sealing member configured to seal the toner in the accommodating space by closing the opening portion,
wherein the discharge passage forming unit includes
an engaging portion configured to be engageable with the engaged portion,
a discharge passage which is configured to communicate with the accommodating space in a state where the discharge passage forming unit is attached to the container unit and through which the toner can be discharged to an outside, and
an unsealing means configured to release sealing of the toner by the sealing member so as to allow the accommodating space and the discharge passage to communicate with each other in a process of attaching the discharge passage forming unit to the container unit,
wherein the discharge passage forming unit is configured to be attachable to and detachable from the container unit in a direction in which the discharge passage forming unit and the container unit are to be aligned, by moving the discharge passage forming unit with respect to the container unit in the direction in which the discharge passage forming unit and the container unit are to be aligned, without rotating the discharge passage forming unit with respect to the container unit, and
wherein the discharge passage forming unit is configured to be detached from the container unit in a case where an engagement of the engaging portion with the engaged portion is released.

27. The developer supply container set according to claim 26,
wherein the container unit includes an inserted portion,
wherein the discharge passage forming unit includes an inserting portion to be inserted into the inserted portion, and
wherein the unsealing means is an end surface of the inserting portion in an insertion direction of the inserting portion with respect to the inserted portion, and the end surface is configured to break through the sealing member in the insertion direction in a process of attaching the discharge passage forming unit to the container unit.

28. The developer supply container set according to claim 26,
wherein at least one of the engaging portion and the engaged portion is configured to deform elastically when the engaging portion engages with the engaged portion.

29. The developer supply container set according to claim 26,
wherein the engaging portion and the engaged portion are configured such that the engagement of the engaging portion with the engaged portion is released by moving the discharge passage forming unit with respect to the container unit in the direction in which the discharge passage forming unit and the container unit are to be aligned.

30. The developer supply container set according to claim 26,
wherein the containing member is a resin bottle.

31. The developer supply container set according to claim 26,
wherein the containing member is a pouch formed of a synthetic resin sheet subjected to pouch processing.
